(19) United States
(12) Patent Application Publication
(10) Pub. No.: US 2009/0020369 A1
(43) Pub. Date: Jan. 22, 2009

(54) Multiple configuration Implement Carrier Kit

(76) Inventor: Michael Christopher Warachka, Headingley (CA)

Correspondence Address: ADE & COMPANY INC., 2157 Henderson Highway, WINNIPEG, MB, R2G1P9, CA

(21) Appl. No.: 12/021,443

(22) Filed: Jan. 29, 2008

(30) Foreign Application Priority Data
Jul. 18, 2007 (CA) 2595196

(51) Int. Cl. B66F 9/06; B66F 9/075

(52) U.S. Cl. 187/231; 187/222

(57) ABSTRACT

This invention relates to an assembly kit composed of quickly easily interchangeable modular components that can be reconfigured in a number of different ways into a number of different versions of a self supporting frame on wheels to form a multimode and multifunction implement carrier. The purpose is: i) to take advantage of a number of different propulsion means, and ii) to accommodate more suitably a wider range of dependent attached small equipment implements than are presently possible on current known related versions of machines referred to as implement carriers, for example utility tractors, front end loader machines and hydraulic boom excavators.

This application claims foreign priority benefits from Canadian Patent Application 2,595,196 filed Jul. 18, 2007.

### FIELD OF THE INVENTION

The present invention relates to a kit of parts for assembly into multiple different configurations of an implement carrier.

### BACKGROUND

Current known related versions of machines referred to as implement carriers, for example utility tractors, front end loader machines and hydraulic boom excavators typically are specific for use on one particular task or type of tasks to be accomplished. Such existing prior art examples which, while not viewed as dedicated implement carriers are about the only machines referred to at present by such term or classification.

Canadian Patent Document 2,432,863 belonging to Luc Belzile and Peter Dale describes a multipurpose load bearing assembly for all terrain vehicles. It is limited however to under-chassis mount on ATVs so is in essence single not multi-mode and it is not an assembly kit which can be adapted to different uses.

Other patents in Canada and the USA researched at CIPO (Canadian Intellectual Property Office) and USPTO (U.S. Patent and Trademark Office) relate only to specific forklift and implement (tool) carriers or improvements thereto and are not multi-mode multi-purpose etc. nor modular assembly kits either and so are far removed.

Several existing models of electric tractors of a single conventional configuration (mostly scaled down agricultural examples) but equipped as implement carriers with 3 point hitches (swing bars and electric linear screws, etc. for lift) and miscellaneous specific tool attachment systems and perhaps individual wheel motors, bidirectional operational modes, are generally limited in the number of functions that they can perform also.

### SUMMARY OF THE INVENTION

According to one aspect of the invention there is provided a kit of parts for assembling into a multiple-configuration implement carrier for supporting a plurality of different implements thereon, the kit of parts comprising:

a frame comprising a base and an upright extending upwardly from the base arranged to support at least some of the plurality of implements thereon spaced above the base; and

a plurality of wheels arranged to support the frame for rolling movement along the ground;

the wheels being arranged to be supported in a first configuration in which a first one of the implements is arranged to be supported on the frame and in a second configuration, different from the first configuration, in which a second one of the implements is arranged to be supported on the frame.

By providing a frame arranged to support the wheels in various configurations, a greater number of different modes of the frame can be achieved for use with a greater number of implements. The purpose is: i) to take advantage of a number of different propulsion means, and ii) to accommodate more suitably a wider range of dependent attached small equipment implements than are presently possible on known equipment and implement carriers.

Unlike conventional possibly existing examples of related implement carriers, the invention described herein is an assembly kit of modular mechanical and electrical units. This offers a key flexibility; it allows select components, component modules, and combinations of these “modules” to be recombined in different configurations. As such, it is a radical digression from the conventional art beyond merely an incremental improvement in an old fundamental form.

On the propulsion side, the machine can accept various power sources from human effort to separate independent vehicle, (whether pulled, pushed or mounted) to an integral on-board power supply ranging from the battery electric example described here to most others. The self propelled battery powered mode and its several configurations (described later) is especially promising in potential with increasing public environmental awareness (pollution and global warming) and therefore renewed interest in clean energy.

On the task or function side the machine can change to an optimized version specific to task. The configuration is thus completely custom assembled and optimized for each situation. For example mowers etc. are preferred at front and plows must be pulled. A grader blade can be pulled or pushed as a dozer/snow plow.

The separation of fuel supply, motive force, and quick interconnection options of these (electric and other) components allows freedom for substantial innovative reconfiguration from the traditional and conventional power train layout and steering options (e.g. front motor rear drive wheels etc.) of common internal combustion models. And the quick change from a spent battery pack module to a fresh one on another pallet or platform can be little more than a matter of swapping fork loads in at least this “thinking outside the box” forklift based example.

Then, like a real life version the familiar Meccano or Lego sets of the toy world, the coupling together of these various modules easily and quickly assembles a variety of configurations: each one optimized to a different task, from the same kit bag of interchangeable modular components referred to herein as the Tultruk. And not just on this “Tultruk” invention; many of these same component elements and modules are usable elsewhere on remote alien machinery. With uniform mating interfaces and connections the motor or PTO module can drive power tools or equipment at a work site, and the substantial mobile battery pack alone is an alternative or auxiliary power supply etc.

Related existing “prior art” examples of implement carriers are single configuration machines such as conventional agricultural tractors, or construction earthwork equipment, excavators, loaders, etc. with various attachments often an afterthought to their primary function. Unlike these present day examples, this invention is a break from the tradition as it is designed from the onset as an implement carrier; the primary purpose of its many different configurations being solely to provide total support to the operation of its dependent implements, i.e. lift, transport, auxiliary power, tool orientation, etc. The invention therefore rather than being an incremental advance in the existing art (one machine with many attachments) is a substantial digression from the constraints of traditional implement carriers and a radical release from their single embodiment constraints. About a hundred years ago, the concept of an automobile was similarly freed from its origins as merely a “horseless carriage”.

The kit is built to engage both the industry standard 3 point hitch mounting frame configuration albeit in a rigid mount as well as novel mounting adaptations. Although most existing 3 point hitch implements tolerating a rigid mounting can be thus accommodated, no drawings of such obvious application are provided. Articulated lift bars of such systems or existing add-on hitches (“Dirtworks” etc.) can be added.

Other quick attachment means as well are incorporated. The mounting holes in its forks make double use of the forks as common implement mounting brackets as well in some adapted or custom designed implements as in the grader/harrow combination “garrow” or the sliding sleeves of the tree spade.

Angle bracket adapters (of plowshare attachment etc.) further reduce most common earthwork draft and other implements to just the relevant tool bit or tool bar.

In addition to that, the stripped down chassis can be mounted with suitable adapters as a forklift attachment onto other common motorized carrier apparatus—tractor 3 point hitch or front end loader frame, truck snow plow lift frame, even the front or rear bumper of e.g. a pickup truck all terrain vehicle etc.

A carriage and forks alone form a simple forks attachment mounted on a tractor 3 point hitch or loader frame.

Some of the kits component units such as the wheel options both powered/unpowered main wheels and casters, booster beam, battery pack, electric motors, reduction gearcases and controls, towbars, etc. in addition to use on the “Tultruk”, can be easily detached at their often unique “Quick Clamp” “Quick Latch” or other common interfaces and used separately elsewhere on other alien machinery with the same compatible attachment interfaces.

As described herein, the first and second configurations of the wheels may be: i) different in lateral spacing relative to one another in a direction transverse to a longitudinal direction of rolling movement of the wheels; ii) different in orientation of a longitudinal direction of rolling movement relative to one another; and/or different in longitudinal spacing relative to one another in a longitudinal direction of rolling movement of the wheels.

Preferably the wheels are mounted on the frame such that the wheels are interchangeable with one another.

The wheels may include at least one caster wheel having a variable direction of rolling movement and at least one fixed wheel having a fixed direction of rolling movement, in which both said at least one caster wheel and said at least one fixed wheel are arranged to be supported on the frame in more than one configuration, and in which the wheels are interchangeable with one another.

In some embodiments, the frame is arranged to be self supporting on the wheels in the first configuration of the wheels and at least partially supported on a hitch of a towing vehicle in the second configuration of the wheels.

Preferably at least some of the wheels are supported on the frame by telescoping members arranged to be supported for sliding movement relative to the frame.

When the frame is arranged to be partially or fully supported on a vehicle, some or all of the wheels may be arranged to be removed from the frame.

When the kit is provided in combination with first and second implements arranged for different functions, the first implement is preferably supported on the frame in the first configuration of the wheels and the second implement is preferably supported on the frame in the second configuration of the wheels.

Examples of implements of existing 3 point hitch type or special design that may be selected from groups comprising but not limited to:

1) agriculture types such as a mouldboard plowshare, rototiller, draft toolbar types such as cultivator, harrow, seeder, rockrake, sprayers, etc.

2) construction types such as: an earth (post hole) auger, pipe or cable puller plow, chain etc. trenchers, barrel mixers (for concrete, etc.), a dump bucket, etc.

3) landscaping and grounds maintenance types such as: lawnmowers, snow plows, snowblowers, grader blades, tree spade, etc.

4) general purpose types such as pallet forks, material bins, tool benches, shop equipment provide mobility and power thereto.

The frame may be comprised of a plurality of first frame members comprising elongate members having an outer dimension of prescribed dimension and a plurality of second frame members comprising elongate members having an inner dimension substantially equal to the prescribed dimension, in which each of the plurality of first frame members being arranged for telescoping connection with each of the plurality of second frame members.

A lift carriage is preferably supported for lifting movement along the upright, the lift carriage being arranged to support at least one of the implements thereon.

The lift carriage may comprise a pair of vertically spaced apart rails spanning generally horizontally and arranged to support the implement thereon. A vertical space between the rails is preferably arranged to be adjustable.

When the frame is arranged to be supported on a vehicle, the lift carriage is preferably movable for lifting movement relative to the vehicle.

The lift carriage preferably includes a 3 point hitch connection arranged to support a 3 point hitch mounted implement thereon.

The lift carriage preferably further includes a plurality of clevis mounts supported thereon, in which at least some of the clevis mounts are vertically and horizontally spaced from one another, at least some of the clevis mounts are adjustable in height relative to one another, and at least some of the clevis mounts are supported on the lift carriage for relative sliding movement in a generally horizontal direction relative to one another.

There may be provided a winch or other lifting device operable between the frame and the lift carriage in a first mode to apply a lifting force to the lift carriage and in a second mode to apply a downward force to the lift carriage.

There may be provided a plurality of motive power mechanisms for the said lifting device including but not limited to an electric motor, hydraulic pump and a manual crank.

There may be provided a pair of horizontal lift forks supported on carriage parallel and spaced apart from one another, the lift forks being arranged to support simultaneously at least one of the implements thereon.

When each lift fork comprises a mounting member arranged to be supported in an upright orientation on the carriage and a lift member extending generally horizontally from one end of the mounting member, the mounting member is preferably mountable on the lift carriage in a first configuration in which the lift member extends from a top end of the mounting member and a second configuration in which the lift member extends from a bottom end of the mounting member.

The lift forks may have mounting apertures at spaced positions therealong so as to be arranged to support simultaneously at least one of the implements thereon using fasteners cooperating with the mounting apertures.

The lift forks may include sleeve members slideably supported thereon, the sleeve members being arranged to support implements thereon.

When there is provided a hitch member supported on the frame, the hitch member is preferably positioned on the upright opposite the carriage.

There may be provided a sleeve mounted on the upright to extend in a generally horizontal orientation and a hitch member arranged to be slideably received in the sleeve for selective separation from the upright.

There may be provided electric motors for driving one of either lifting of the lift carriage relative to the frame or rolling of the frame relative to the ground. The electric motors are preferably powered by batteries arranged to be supported and distributed anywhere on board as single interconnected units or massed, but preferably on the forks.

When there is provided i) a drive for driving rolling movement of the frame across the ground, ii) an operator's control column (not the electronic motor controller) for operating the drive, and iii) a seat for supporting an operator thereon, the operator's control column and the seat are preferably arranged to be selectively supported on the upright.

Preferably there is provided at least one modular motor unit arranged to drive rotation of one of the wheels, the modular motor unit being mountable in a first position engaged for driving one of the wheels and in a second position engaged for driving a different one of the wheels.

When there is provided a lift carriage supported for lifting movement along the upright, the modular motor unit may be mountable in a third position for driving the lifting movement of the lift carriage along the upright.

When there is provided an implement requiring motive power, the modular motor unit may be mountable in a fourth position connected to said implement.

When there is provided a pair of modular motor units arranged to be interchangeably engaged with a respective pair of the wheels for driving rotation of the respective pair of wheels, the modular motor units may be operable to selectively drive the respective pair of the wheels at different rates of rotation in either direction such that the frame is steerable and operable in “zero turn radius” mode or a skid steer mode relative to the ground.

There may be provided a drive for driving rolling movement of the frame along the ground and a hitch member connection arranged to be selectively supported on the frame for towing or pushing by the assembled kit.

According to another aspect of the present invention there is provided a kit for assembling a multiple-configuration implement carrier for receiving and retaining removable tools, comprising:

at least one mast member;

at least two support braces for mounting on the at least one mast member;

first wheel mounting means for attachment to a lowermost of the at least two support braces;

at least one first wheel assembly for connection to the first wheel mounting means;

extensibly adjustable leg members for mounting on opposite ends of the lowermost of the at least two support braces;

second wheel mounting means for attachment to the extensibly adjustable leg members spaced from the at least two support braces;

at least one second wheel assembly for connection to the second wheel mounting means; and

at least one tool-receiving member for connecting to any of the at least two support braces, comprising tool-mounting means thereon for removably receiving and retaining tools.

The extensibly adjustable leg members may be selectively mountable in a first configuration wherein the leg members are extensible in a forward direction or in a second configuration wherein the leg members are extensible in a rearward direction.

The tool-mounting means may comprise a plurality of apertures for receiving engagement members of a tool.

One of first wheel assembly or the second wheel assembly preferably comprise caster wheels.

There may be provided a winch or lifting assembly for selectively mounting on one of the mast member and any of the at least two support braces, whereby the tool-receiving member is for connecting to any of the at least two support braces by means of the winch or lifting assembly. Preferably the winch or lifting assembly is for selectively raising and lowering the tool-receiving member relative to the at least two support braces.

There may be provided two mast members for positioning in a horizontally spaced orientation, such that, when assembled, the lower ends of the two mast members are connected by the lowermost of the at least two support braces.

According to another aspect of the present invention there is provided a multiple-configuration tool (i.e. implement) carrier comprising:

at least one mast member;

at least two support braces mounted on the at least one mast member;

first wheel mounting means attached to a lowermost of the at least two support braces;

at least one first wheel assembly connected to the first wheel mounting means;

extensibly adjustable leg members mounted on opposite ends of the lowermost of the at least two support braces and selectively orientatable in a forward direction or a rearward direction;

second wheel mounting means attached to the extensibly adjustable leg members spaced from the at least two support braces;

at least one second wheel assembly connected to the second wheel mounting means; and

at least one tool-receiving member connected to any of the at least two support braces, comprising mounting means thereon for removably receiving and retaining tools;

wherein in a first configuration the extensibly adjustable leg members are oriented in a forward direction; and

wherein in a second configuration the extensibly adjustable leg members are oriented in a rearward direction.

According to yet another aspect of the present invention there is provided a multiple-configuration tool carrier comprising a vertically-adjustable toolreceiving member and generally horizontally disposed selectively orientatable leg members;

wherein in a first configuration, the tool-receiving member is disposed at a first height relative to the leg members and the leg members are oriented in a forward direction; and,

wherein in a second configuration, the tool-receiving member is disposed at a second height relative to the leg members, the second height spaced from the first height, and the leg members are oriented in a rearward direction.

Some embodiments of the invention will now be described in conjunction with the accompanying drawings in which:

### BRIEF DESCRIPTION OF THE DRAWINGS

In the drawings like characters of reference indicate corresponding parts in the different figures.

FIG. 1 is a perspective view of the kit assembled as an implement carrier in a manual push straddle leg forklift mode in which the manual hand crank of winch is not shown.

FIG. 2, FIG. 3 and FIG. 4 are respective rear elevational, top plan and side elevational views of the implement carrier according to FIG. 1.

FIG. 5 is a side elevational view of the assembled implement carrier in which the wheels have been interchanged with one another in relation to FIG. 4.

FIG. 6A is a side elevational view of the assembled implement carrier of FIG. 5 when assembled in a one of the crab steer scaffold configurations. The fixed main wheels have been turned to a transverse orientation and forks are installed inverted.

FIG. 6B is a side elevational view of the assembled implement carrier in a crab (sideways) travel configuration as a variation of FIG. 6A in which the main wheels and caster wheels have been interchanged.

FIG. 6C is a side elevational view of the assembled implement carrier in a crab travel configuration wherein the main (fixed orientation) wheels are both on one side of frame to offer a more easily steerable sideways travel. Another subset of configurations (not shown) can have leg members positioned in a rear of the chassis.

FIGS. 7 through 11 describe configurations which can be powered by and can be attached to a separate motor vehicle for mobility and electric power.

FIG. 7 is a side elevational view of the assembled implement carrier in a full trailing, four wheel rear caster mode.

FIG. 8A is a side elevational view of the assembled implement carrier in a semi-trailer configuration with telescoped (shortened) leg members shown with a mouldboard plowshare supported thereon.

FIG. 8B is a side elevational view of the implement carrier in a semi-trailer sub mode with the leg members removed entirely and the wheels attached directly under the chassis with two harrow bar/grader blade combination tool bars in tandem supported thereon.

FIG. 9 is a side elevational view of the assembled implement carrier in one of the crab travel modes. Other configurations for lateral travel are possible by sliding, relocating of legs and interchanging wheels as in previous drawing examples. A hitch tongue is shown in a side view and detached for clarity.

FIG. 10 is a side elevational view of the implement carrier in a semi-trailer tandem wheel mode.

FIGS. 11A and 11B are direct steering modes using two tow tongues connected to the bumper of a traction vehicle to form a rigid attachment.

FIG. 11A is a side elevational view of the assembled implement carrier shown in a front pusher mode with a dozer blade or snow plow supported thereon.

FIG. 11B is a side elevational view of the assembled implement carrier in a direct steering puller mode attachable to a rear bumper.

The following FIGS. 12 to 17D inclusive describe a third mode of propulsion (self propelled battery electric) and drawings illustrate some of the possible configuration examples.

An additional kit of modular electric components is provided which includes batteries, an operator's control column, electric motors and gear reducers of interest. Power cables, control wiring and electronic controllers are considered a standard requirement and not discussed or shown in drawings.

The electric powered components such as main wheels, lift actuators, as well as all connected implements of the assembly kit are preferably powered by a single type of electric power unit; the universal electric power take off (PTO) Module consisting of a variable speed reversible electric motor and a gear reducer. All connecting interfaces are the same so that any combination of motor, or motor gearcase combo (electric PTO), can be used in any required application thereon. Despite the fact that some drawings show different electric motors or gearmotors, one of the electric PTOs is preferred as it is available, has compatible voltage, is controllable in variable speed and torque output, is reversible and has the uniform connecting interface.

FIG. 12A is a side elevational view of the assembled implement carrier in an electric walkie version favoring light implements wherein the operator can be pedestrian but the other functions (ground and implement drive) are electric powered. An earth auger is shown is shown being powered by the electric PTO module.

FIG. 12B is a side elevational view of the assembled implement carrier in a four wheel electric rider mode supporting and powering a heavier implement (barrel mixer) thereon. The larger driven wheels here are in front for improved load support and tractive force.

FIG. 13 is a side elevational view of the assembled implement carrier in a mobile (side travel) steerable scaffold mode. The fixed direction main wheels are shown powered by the preferred electric PTO modules inside the wheel hubs and the operator's control column module is located within reach of scaffold rider.

FIG. 14A is a side elevational view of the assembled implement carrier in a seated rider mode shown with a rotary mower supported and powered thereon at front. The tricycle configuration with a twin “gullwing” caster assembly (as shown) at rear facilitates the sharp 0 radius turns and the necessary substantial battery packs for mowing can be atop forks for quick drive in drive out exchange.

FIG. 14B is a side elevational view of the assembled implement carrier in an electrically driven tricycle gear rider configuration similar to FIG. 14A. The operator's seat and control column face rearward however in this bidirectional (rearward) mode, that is, opposite to the direction the forks face and it can be provided with the tow tongue for assistance from another vehicle if necessary.

FIG. 15 is a side elevational view of the assembled implement carrier in an electrically powered 4 wheel configuration with the operator's position forward and attached to carriage. It may suit gardening or orchard row crop tasks. A similar but bidirectional rearward variant is not shown.

FIG. 16A is a side elevational view of the assembled implement carrier in an electrically powered 4 wheel forward travel mode; a configuration similar to the most common conventional rider type counterbalanced forklift. Legs and casters are in the rear and a platform spanning across can support massed battery packs and other counterweight.

FIG. 16B is a side elevational view of the assembled implement carrier in an electrically powered rearward travel mode. It is a similar configuration to FIG. 16A except that the bidirectional seat and control column face the rearward operational direction. A hitch ball fastened to carriage makes it into a light duty electric tractor with an elevating hitch.

Figures in the 17A, 17B, 17C and 17D subset are considered the heavy duty configurations as they use four powered wheel modules to essentially double weight capacity and potential mechanical power output as well as improve stability, flotation etc.

FIG. 17A is a side elevational view of the assembled implement carrier in a tandem power wheel configuration known as a skid steer rider mode. The caster wheels may be added to the rear in leg insert tubes 14 or under seat post 78 as shown to stabilize the movement and provide additional support platforms for the batteries (not shown). Pedestrian, standing rider and bidirectional rearward travel variants (no drawings) of the skid steer mode group are also possible.

FIG. 17B is a side elevational view of the assembled implement carrier in a 6 wheel forward travel mode with 4 main wheels electrically powered in front. Casters are installed in a second pair of legs in the rear. A platform across these rear legs can support massed batteries.

FIG. 17C is a side elevational view of the assembled implement carrier similar to FIG. 17B but in the bidirectional rearward travelling mode. With a dump body as shown on forks it is the all terrain utility vehicle version; with a hitch provision it can be a heavier duty conventional tractor.

FIG. 17D is a side elevational view of the assembled implement carrier with the two pairs of tandem wheels shifted rearward with respect to the previous three configurations. With an earth scraper bucket as shown it can be the “front end loader” embodiment.

FIG. 18 is a side elevational view of the assembled implement carrier with legs and fixed main wheels removed configured as a forklift attachment to be mounted on a 3 point hitch or loader frame of a supporting vehicle.

FIG. 19 is a side elevational view of the lift carriage and lift forks shown separated from the frame of the implement carrier. This further reduction configures it more simply a forks attachment only to the three point hitch or loader frame of a supporting vehicle.

FIG. 20 is a perspective view of the lift forks shown with two of the four tree spade attachments supported thereon.

FIG. 21A is a side view of the two quick attach wheel module types belonging to the kit for assembly into an implement carrier including the preferred quick attach in-the hub insert motor/gearcase modules (universal electric PTOs) that may power the main (fixed orientation) wheels, any of the lift mechanisms, the on board implements and possibly other devices. A caster wheel in side view is also shown.

FIG. 21B is a detail drawing of the carriage, (removable end bearings not shown), a U bolt clamp type and a sliding sleeve type of implement mount receivers (clevis type) and the winch mast assembly with the dual powered winch.

FIG. 22 is a schematic illustration of some accessories belonging to the kit for assembly into the implement carrier including a bidirectional seat 74 with operator's control column 86 to be mounted within reach of the operator (shown mounted on seat post 78), a pulley, a clamp on wheel mount adapter, a clevis adapter, a booster bar, a T-bar, a sway bar, a two piece tow tongue and a hitch ball.

FIG. 23 illustrates a possible alternate use of certain components of the assembly kit on alien equipment; in this example a cart.

In the drawings like characters of reference indicate corresponding parts in the different figures.

### DETAILED DESCRIPTION

Referring to the accompanying figures there is illustrated a kit of parts generally indicated by reference numeral 10. The kit 10 is particularly suited for assembly into a multiple configuration implement carrier for carrying a plurality of different implements thereon in different configurations of the parts. In each configuration, the carrier is arranged to support an implement thereon of the type which may be carried on a frame for rolling movement across the ground or which can be supported on a three point hitch as examples. Various configurations of the kit are shown in the attached drawings and the following description, however in each instance the kit of parts includes a core configuration which is generally in common with the other configurations.

In each instance there is provided a base 12 to support the assembly for rolling movement across that ground. The base generally comprises two tubes 14 which are mounted parallel and spaced apart from one another to be oriented to lie generally horizontally spaced above the ground. A cross bar 16 is connected between the two tubes 14 at a mid-length therealong so as to be perpendicular to the tubes and form a generally H-shaped structure therewith.

The tubes 14 include opposed open ends 18 which are each arranged to receive a respective wheel mount 20 therein. The wheel mounts 20 are available in a variety of configurations, but in each instance a portion of the wheel mount is telescopically received within the open end of the tube 14 to support the assembly for rolling movement in a forward direction 22 in a longitudinal direction of the tubes in most instances.

In addition to the base 12, the frame includes two uprights 24, each comprising a vertically extending rigid frame member mounted on a respective one of the tubes 14 centrally thereon to extend upwardly and perpendicularly in relation thereto. Each upright 24 comprises a generally U-shaped channel having a base flange and two side flanges projecting from opposing sides thereof parallel and spaced from one another so as to define an open side along the length of the channels. The channels are oriented so that the two uprights 24 are parallel and spaced apart from one another with the open sides thereof confronting and facing one another.

A lift carriage 26 is slideably mounted along the uprights 24 to span between the open sides of the uprights for sliding movement therealong in a vertical direction. The carriage 26 comprises two horizontal rails 28 which are mounted vertically spaced apart from one another. Each rail 28 includes an end 30 adapted for sliding movement along the interior of the respective one of the U-shaped channels forming the uprights 24 by action of a wheel, roller or slider of material having a low co-efficient of friction. A vertical post 32 is connected between two rails 28 at a laterally centered position therealong between the two uprights 24. The post 32 comprises upper and lower sections which are telescopic relative to one another to adjust the length thereof and accordingly adjust the vertical spacing between the two rails 28. A suitable locking pin is received through cooperating apertures in the upper and lower sections of the post 32 for selectively locking the post at a designated length or height thereof.

A plurality of implement mounts 34 are provided on the carriage 26 upon which various implements can be supported. In the preferred embodiments, the implement mounts each comprise a clevis or tang supported for sliding movement along the respective rail. Each implement mount 34 includes a tube 36 supported about the respective one of the rails 28 upon which it is mounted for lateral sliding movement therealong in the horizontal direction of the rail. Two or more implement mounts 34 are supported on each of the two rails 28 in which the two mounts 34 are both slidable along the rail so as to be adjustable in horizontal spacing relative to one another. When adjusting the height of the post 32 between the two rails 28, the vertical spacing between the implement mounts 34 on the two different rails 28 can accordingly be adjusted in vertical spacing or height relative to one another as well. When the implement mounts each comprise a clevis, two vertically spaced apart vertical plates 38 project upwardly and forwardly from the respective tube 36 so as to project forwardly and outwardly beyond a plane spanning the two uprights 24. Due to the adjustability of the relative horizontal and vertical spacing between the implement mounts 34, the implement mounts can be readily set at a suitable spacing for supporting a conventional three-point hitch mounted implement thereon by matching the relative spacing between the mounts on various commercially available three-point hitch connections.

An auxiliary support 40 is provided on the frame which extends vertically, spaced and parallel from the uprights so as to be essentially centered in a lateral direction between the two uprights while being positioned rearwardly from the plane spanning between the uprights in a direction which is opposite the forwardly projecting implement mounts 34. The auxiliary support comprises a rigid frame member joined centrally on the crossbar 16 of the base 12 of the frame by a support leg 42 spanning horizontally in the longitudinal direction between the bottom end of the support 40 and center of the crossbar. The auxiliary support 40 is further supported by an additional crossbar 44 joined between the uprights across a rear side thereof opposite the forwardly projecting implement mounts 34. The crossbar 44 extends horizontally between the uprights, so as to be generally perpendicular thereto at a location corresponding approximately to a mid-height or vertical center of the uprights. The auxiliary support 40 extends vertically upward beyond the crossbar 44 adjacent to the rear side thereof so that the crossbar 44 is joined between the uprights and the auxiliary support 40 due to the auxiliary support 40 being spaced rearwardly from the plane of the uprights only by the thickness of the crossbar. A vertical sleeve 46 is attached to the rear of the crossbar at a central location thereon for slidably receiving the auxiliary support 40 therethrough. Height of the auxiliary support 40 can thus be adjusted by sliding adjustment through the sleeve 46. A similar sliding and locking pin connection through cooperating apertures can be provided between the bottom of the auxiliary support 40 and the support leg 42. Accordingly the auxiliary support 40 can be interchanged with supports of varying height or varying configuration as may be desired. In the preferred embodiment, the support 40 has a height which is near the height of the uprights.

Position of the lift carriage 26 along the uprights can be controlled by a lift actuator 48 which in the illustrated embodiment comprises a combination manual-electric winch mounted to the top end of the auxiliary support 40. A cable extends from the winch for connection to the lift carriage 26 so that actuation of the winch effectively raises or lowers the lift carriage in a lifting or lowering movement along the uprights. A pulley attachment 50 may be provided for attachment of a pulley to anyone of various frame members of the kit to vary the orientation of the cable pulling on the lift carriage (upwards or downwards) if desired. Accordingly the lift actuator is operable in a first orientation where force of the lift actuator causes the lift carriage to be raised in relation to the uprights, or alternatively in a second orientation, force of the lift actuator 48 may cause the lift carriage 26 to be lowered in a downward direction relative to the uprights. The second orientation is particularly suited when a ground engaging implement is supported on the lift carriage and it is desired to engage the implement downwardly into the ground with greater force or for a “hitchhiker” transport mode wherein machine is supported by means of the forks on a carrier vehicle.

The kit further includes a mounting sleeve 52 which is adjustably supported on the vertical auxiliary support 40. The mounting sleeve 52 is supported by a vertical support sleeve 54 which is mounted for vertical sliding movement along the support 40. A locking pin and cooperating aperture again act to selectively restrict sliding movement of the support sleeve relative to the auxiliary support 40 in a preferred orientation. The mounting sleeve 52 is fixed to one side of the vertical support sleeve 54 to project horizontally in relation to the auxiliary support 40. The open end of the mounting sleeve 52 is suitably arranged for receiving the stem of a hitch member, operator's seat, or various other accessories so that these accessories are supported to be vertically adjustable along the auxiliary support 40.

The wheel mounts 20 include first mounts for mounting caster wheels 56 onto the base of the frame, and second mounts for mounting fixed orientation wheels 58 on the base. The wheel mounts 20 for the castor wheels 56 generally include a stem 60 which is receivable into the open end of the base tube. From the horizontal stem 60, a vertical member extends upwardly from one end thereof and a horizontal member projects horizontally from the top end of the vertical member opposite the stem 60 for locating the caster wheel 56 below the free end of the horizontal member for rotation about a vertical axis pivot which permits the rolling direction of the castor wheel to be variable about a vertical axis.

The wheel mounts 20 for mounting the fixed orientation wheels 58 on the frame generally comprise an upright mounting plate 60 supporting a flange at right angles thereto along one edge. An opposing edge of the mounting plate 60 is inclined upwardly and outwardly opposite the right angle flange. Suitable fasteners, for example L-shaped bolts permit fastening of the mounting plate and corresponding right angle flange in a clamping configuration onto any of the elongate frame members forming the base of the frame. The fixed orientation wheel 58 is supported on the upwardly extending and outwardly inclined portion of the mounting plate 60 so that when the mounting plate is clamped onto one of the frame members of the base which are generally square in cross section, the axle supporting the corresponding wheel thereon extends outwardly at a generally downward incline from the mounting plate and the wheels rotatable thereon may be accordingly inclined upwardly and outwardly away from each other when the mounting plates are supported on opposing outer sides of the base 12 of the frame 12. Auxiliary frame members 62 are provided for telescoping insertion into the open ends of the tubes 14 of the base to support any of the wheel mounts 20 farther from the base in the longitudinal direction if desired. When supporting the fixed orientation wheels 58 thereon, the auxiliary frame members 62 permit the wheels to be telescoped in the longitudinal direction of the tubes and in the rolling direction of the wheels in either forward to rearward directions of the frame depending on whether the auxiliary member and wheels supported thereon are mounted in the front open ends or the rear open ends of the tubes 14 of the base.

The arrangement of the wheels permits the caster wheels 56 to be readily interchanged with the fixed orientation wheels 58 having a fixed rolling direction once mounted, due to the stem 60 and the auxiliary frame members 62 being interchangeable with one another within the tubes 14 in telescoping mounting configuration.

Variation of the configuration of the wheels is desired when supporting different implements thereon so that the wheel configuration is suited to the particular implement being supported. The wheels are thus arranged to be supported in a first configuration in which a first one of the plurality of implements is supported on the frame and in a second configuration, different from the first configuration, in which a second one of the plurality of implements is supported on the frame. The configuration of the wheels permits the wheels to be supported for different lateral spacings between the wheels in a direction which is perpendicular to the longitudinal direction of rolling movement of the wheels as well as permitting the wheels to be adjustable in different orientations of the longitudinal direction of rolling movement and furthermore being adjustable for different longitudinal spacing in the direction of rolling movement. In some embodiments the frame may be fully supported on the wheels so that the implement supported on either the lift carriage or the uprights of the frame is fully supported by the wheels for rolling movement on the ground. Alternatively a hitch may be inserted through the mounting sleeve 52 in which case at least part of the frame and the implements supported thereon are instead carried by the hitch of the towing vehicle. In this instance, the wheels are configured for optimal placement behind a towing vehicle. The wheel mounts 20 further permit the wheels to be completely removed from the base of the frame by simply removing locking pins or bolts through cooperating apertures in the telescoping members of the stem 60, auxiliary member 62 and the tubes 14.

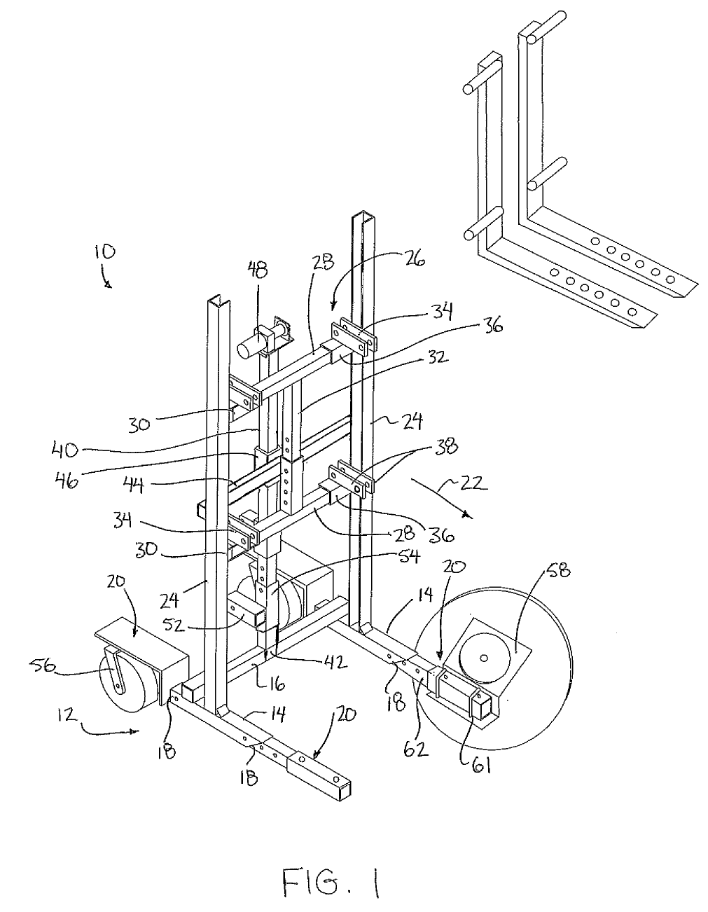

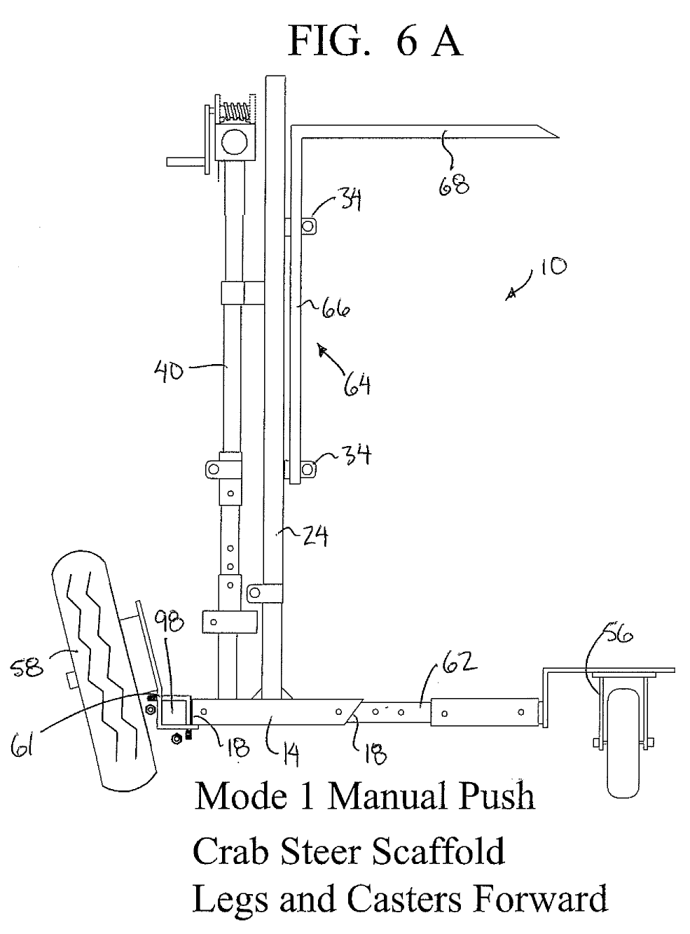

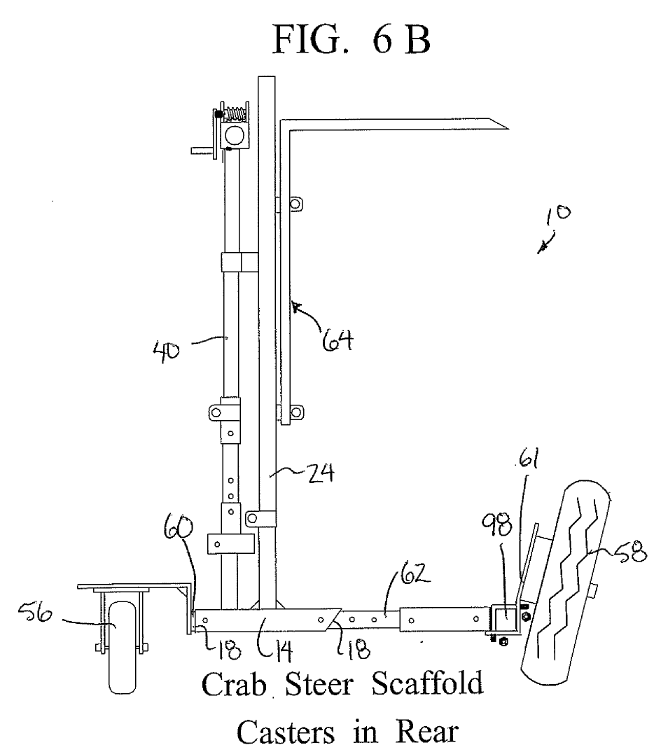

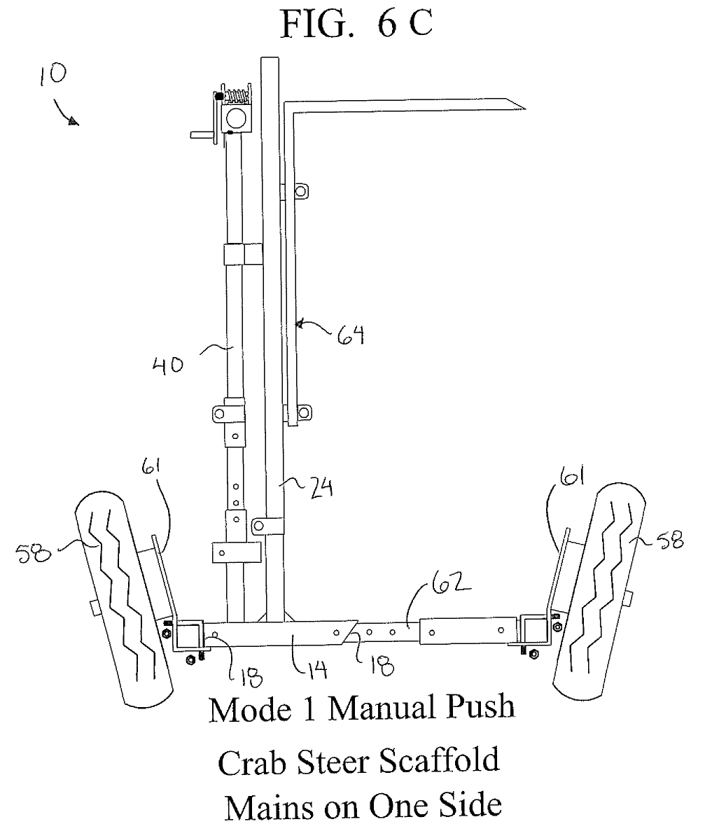

Many embodiments of the assembly make use of a pair of lift forks 64 arranged to be supported on the lift carriage. Each lift fork 64 comprises a mounting member 66 arranged to be supported in an upright orientation on the carriage, and a lift member 68 mounted perpendicularly thereto. The lift member is arranged to extend horizontally from one end of the mounting member 66 when the mounting member is vertically supported on the carriage. The mounting member 66 is selectively supported on the carriage by a pin connection 70 at both top and bottom ends of the mounting member 66 so as to be suitably spaced with one another for alignment with the respective vertically spaced rails of the lift carriage. More particularly each pin connection of the lift forks is arranged for being receive within cooperating apertures in the clevis mount of a respective one of the implement mounts 34 on the lift carriage. The pin connections permit the lift forks 64 to be mounted in two different orientations. In a first configuration as shown in FIG. 6 for example, the mounting member is mounted so that the lift member 68 projects horizontally outward from the top end of the mounting member so that two lift forks 64 together form an elevated lifting platform which can be raised well above the height of the uprights. Alternatively in a second mounting configuration, the lift members 68 are oriented to project from the bottom ends of the mounting members 66 respectively so that in a preferred palette lifting confirmation as shown in FIGS. 1 through 4 for example, the members 68 can be positioned close to the ground when the lift carriage is in its lowermost position.

The lift forks 64 include a plurality of mounting apertures 72 therein at spaced positions along each of the lift members 68. Fasteners are provided for securing implements directly to the lift forks by fastening through the mounting apertures 72 on the horizontal lift members 68 of the lift forks.

As shown in the accompanying Figures, the components noted above can be assembled in various configurations in which various different implement configurations can be supported thereon. Other components of the kit 10 for assembly into a multi configuration implement carrier are shown in FIGS. 21 and 22. In particular a seat 74 is provided which permits a single operator to be seated thereon. The seat 74 is typically supported on a horizontal leg member 76 which is arranged to be telescopically received within the mounting sleeve 52 and secured thereto by a suitable pin and cooperating aperture connection. A seat post 78 is mounted at the opposing end of the leg member 76 in a sliding crosspiece to allow horizontal and vertical adjustment of seat and insert other accessories e.g. a tow tongue thereto. The seat post 78 comprises telescoping sections to permit the seat 74 to be vertically adjusted in relation to the leg member 76. The seat assembly may further include an auxiliary mounting sleeve 80 which is supported at the bottom end of the seat post 78 to extend horizontally in the longitudinal direction of the leg member and of the base of the frame when supported thereon. The mounting sleeve 80 permits the hitch member or other members to be telescopically received therein similarly to the manner in which they are to be mounted within the mounting sleeve 52 on the upright support 40 of the frame.

The kit 10 also includes a plurality of electric motors with detachable gearcases (electric power take off) modules 82, for quick coupling attachment to either the fixed orientation wheels 58, or any of the lift actuators 48. The motors for driving rotation of the wheels and for driving lifting and lowering motion of the lift carriage along the uprights are thus interchangeable with one another. These same motor/gearcase modules 82 may further be used for providing any power requirements to implements supported on the frame, or for powering separate equipment such as a farmer's grain auger as a mobile power take off unit.

A plurality of battery modules 84 are also provided on the frame to provide power to the motor modules 82. The battery modules may be carried anywhere distributed on lower portions of the frame directly on the wheel mounts or platforms available, or on support bases spanning the frame. In some embodiments however the substantial battery weight can be massed or distributed to advantage for traction, balance and stability etc. or rest on a quick exchange base on the forks. For added downforce on implements.

An operator's control column module 86 is provided for permitting an operator to control separately the speed and torque of each individual motor module 82 whether applied to one of the wheels to drive (differential speed steering) rotation of the wheels, the lift actuator 48 for driving lifting movement of the lift carriage relative to the upright, or any associated implement. The operator's control column module 86 can be selectively mounted onto any of the square tube frame members of the kit such as a mast, seat boom, seat post, or the carriage by suitable fasteners. The electronic controllers and interconnecting cables are not shown in drawings.

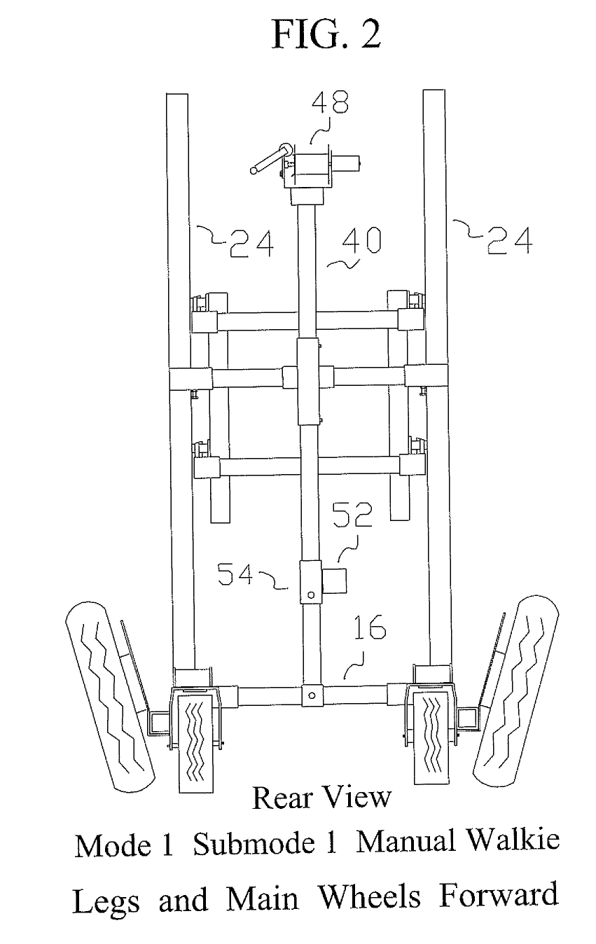

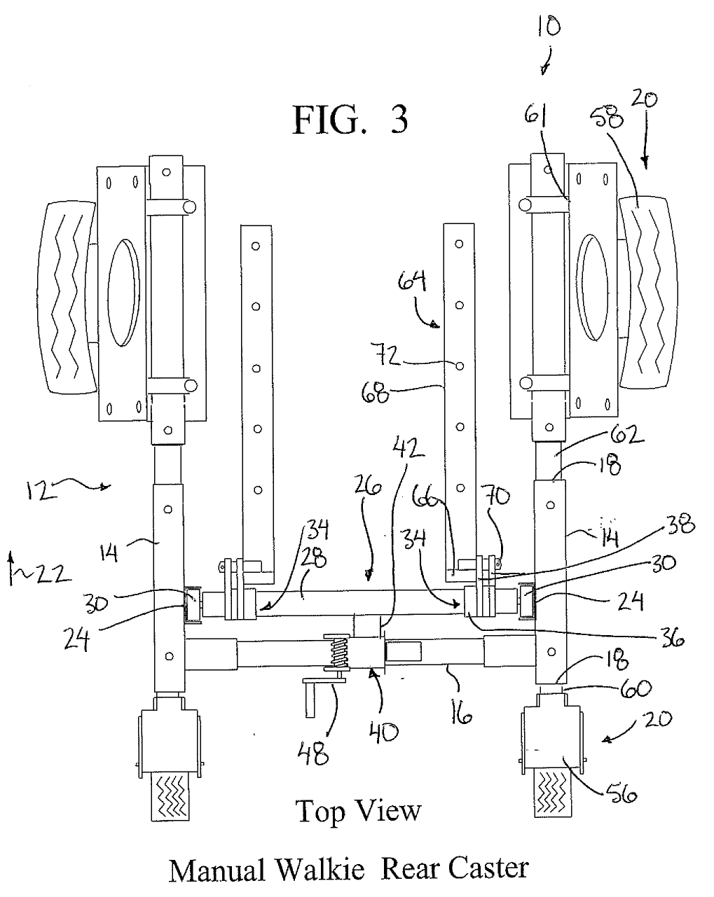

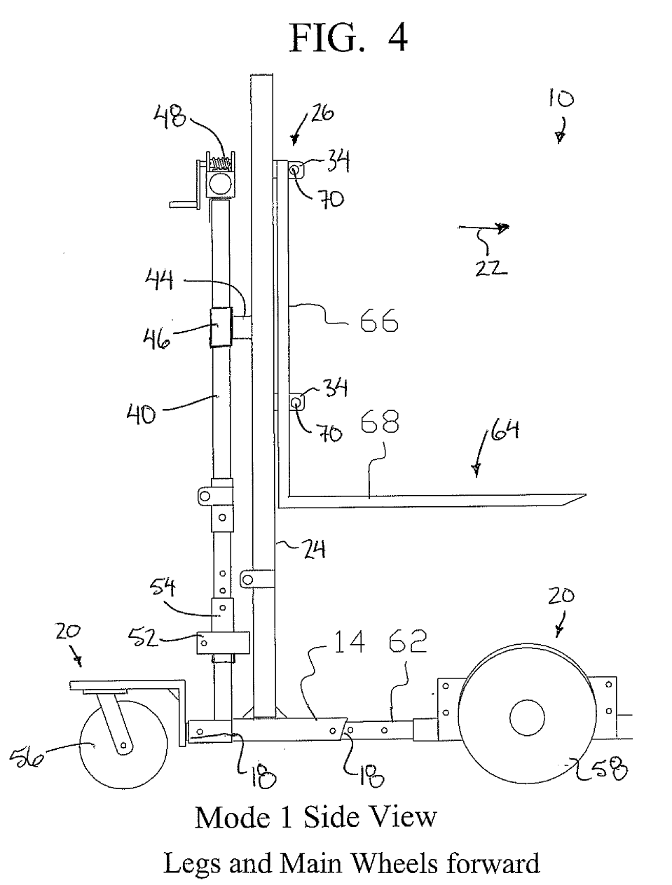

One embodiment of a hitch member 88 is illustrated in FIG. 2 in which the tongue comprises two overlapping members arranged to extend in a generally common longitudinal direction in which a first one of the members is telescopically received within the mounting sleeve 52 on the frame while a hitch connector is mounted at the opposing end of the hitch member 88. The configuration of the seat 74 to include an auxiliary mounting sleeve 80 or a sliding crosspiece permits the hitch member 88 to be received therein for example so that a combination of the hitch member, a seat and an operator's control column module may all be together supported within the mounting sleeve 52 on the auxiliary support 40 of the frame.

A plurality of first auxiliary clevis adapters 89 is provided for clamping onto any of the frame members wherever desired using suitable U-bolts which secure the clevis adapter 89 wherever the user prefers. The clevis adapter 89 similarly comprises two parallel plates or tangs with cooperating apertures at opposing ends thereof for receiving a pin connector of an implement therethrough.

A plurality of second clevis adapters 90 are provided, each in the form of a stem arranged to be telescopically received in the open ends of the tubes 14 of the base in place of the wheel mounts 20 in which a pair of parallel and spaced apart plates are mounted to project outwardly from the opposing end of the stem. Cooperating apertures in the free ends of the plates of the second clevis adapter 90 permit connection of a suitable implement pin connection therethrough.

Among the various components, there is also provided a plurality of wheel adapters in the kit 10 in which the wheel adapters 92 comprise a tube of square cross section arranged for telescoping connection with one of the frame members and having a pair of mounting flanges projecting therefrom at right angles for securing the wheel mounts thereto by mounting apertures in the flanges of the wheel adapter 92.

The components of the kit 10 further include a plurality of sway bars 94 comprising an elongate bar with inclined flanges at opposing ends thereof with mounting apertures therein. A booster bar 96 is provided in the form of an elongate frame member with mounting apertures at spaced positions therealong for telescoping or bolting connection to any one of various frame members of the kit 10. The booster bar 96 may be used as auxiliary frame members 62 in the base for supporting the wheel mounts thereon. A plurality of T-bars 98 are also provided in the form of two frame members attached in a T-shaped configuration relative to one another in which one or both of the members forming the T-bar 98 are arranged to be mounted in telescoping configuration with other frame members of the kit 1 0.

In addition to the hitch member 88, two hitch ball assemblies 99 may be provided in the kit 10 in the form of a mounting plate having two flanges at right angles for bolted connection to one of the components of the frame or to an attached vehicle. The ball of the hitch ball 99 is supported on one of the flanges.

In general, all of the frame members of the kit 10 generally comprise one of a plurality of first frame members of a plurality of second frame members. Each of the frame members comprises an elongate rigid member of generally square cross section in which the first elongate frame members have an outer dimension substantially equal to the inner dimension of the second frame members so that the first frame members are arranged for telescopically being received within any one of the second frame members. Cooperating apertures are also provided in all of the frame members for fixing the orientation and position of the frame members relative to one another at any one of various selected positions using suitable pin connections or mating fasteners including bolts and the like. This arrangement of frame members readily permits the components of the kit 10 to be assembled into multiple configurations, each supporting a different implement thereon. In addition to the different orientations of the frame members, the frame can also be driven for rolling movement along the ground in different manners. Power can be provided directly to the rigidly oriented wheels through motor modules 82 or alternatively the frame can be towed using the hitch member 88. Two frame members 88 can also be used for attachment in a rigid (non pivoting) manner to a vehicle providing the motive force. When a plurality of motor modules 82 are provided on respective wheels at opposing lateral sides of the frame, the operator's control column module can be arranged so that in addition to driving rolling movement of the frame in the longitudinal direction of rolling movement of the wheels, the direction and speed of rotation of the wheels can be varied relative to one another to steer the frame in a manner similar to a skid steer i.e. in a “zero turn radius” configuration.

A further detailed discussion of some drawings will now be discussed.

The invention has symmetry about the central longitudinal axis.

Components not specifically defined are deemed self evident.

Common hardware attachment devices such as bolts, pins, etc. are not shown to avoid clutter. Neither are some larger ones such as frame braces, swivel joints, power cables, electronic controllers, etc. if not material to novelty claims.

Turning now more particularly to particular configurations of the kit 10, FIGS. 1 through 4 illustrate different views of a manually propelled configuration in which the lift forks are supported on the lift carriage to project forwardly from the plane of the uprights. In this embodiment the wheel mounts are arranged to also telescopically extend forwardly for locating fixed wheels directly below the free ends of the lift forks while caster wheels are supported to project rearwardly from the base opposite the lift carriage. The lift actuator in this instance comprises a winch arranged to lift the lift carriage along the uprights when actuated. The particular lift actuator shown in the embodiments (except FIG. 1, the title sheet drawing) is a combination of an electric winch with an additional removable manual crank and worm gear drive attachment (not shown) whose mount bracket allows selective engagement or removal as desired.

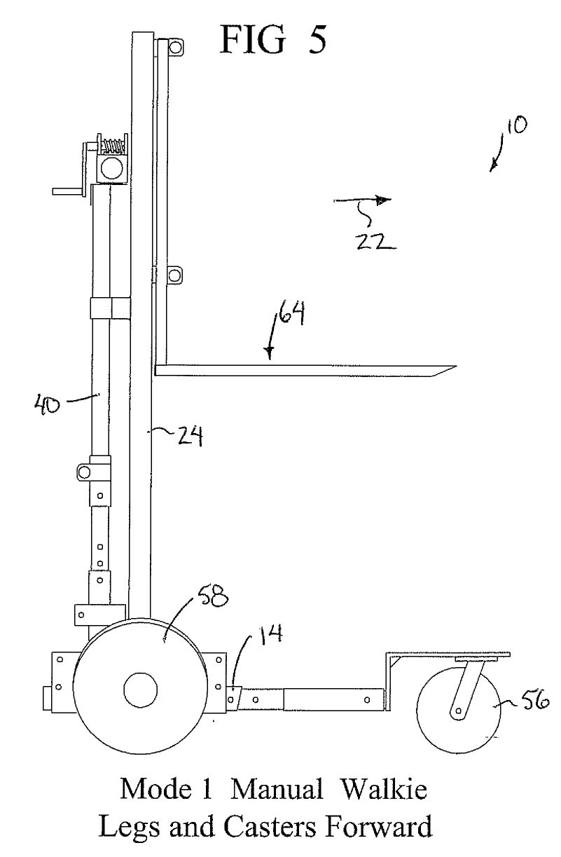

Turning now to FIG. 5, a similar configuration is illustrated in which the caster wheels and the wheels of fixed orientation are interchanged in relation to the previous embodiment so that the caster wheels are located at the front end of extension members below the free ends of the lift members respectively instead of rearward from the frame as in the previous embodiment, and wheels of fixed orientation are clamped directly to the longitudinally extending tubes 14 of the base frame so as to be located near the rear of the frame instead of at the forward end of the extension members as in the previous embodiment.

FIG. 6A illustrates a further configuration of the kit 10 in which the lift forks are mounted in an inverted configuration relative to the previous embodiments so that the lift members extend from the top end thereof to form a raised platform or scaffold structure where the lift members can be raised well above the height of the uprights. When operated as a scaffold, it may be desirable for the wheels to be varied in orientation to have a rolling direction which is perpendicular to the longitudinal direction of the tubes 14 of the base frame. This can be arranged by clamping the wheels of fixed orientation onto T-adapters inserted into rear of tubes 14 for lateral travel along a wall or narrow aisle etc. The caster wheels can be mounted on the extension members at the forward ends thereof so as to be located below the free ends of the lift forks.

FIG. 6B is a simple variation of 6A wherein the wheels of fixed orientation are transposed with the casters.

FIG. 6C is another relocation of wheel gear so as to be more easily steerable.

Other versions involving telescopic sliding or reinsertion from rear of extensible leg members etc. are possible but not drawn.

The previous embodiments represent some of the configurations possible in the Mode 1 or pedestrian operator pushed mode.

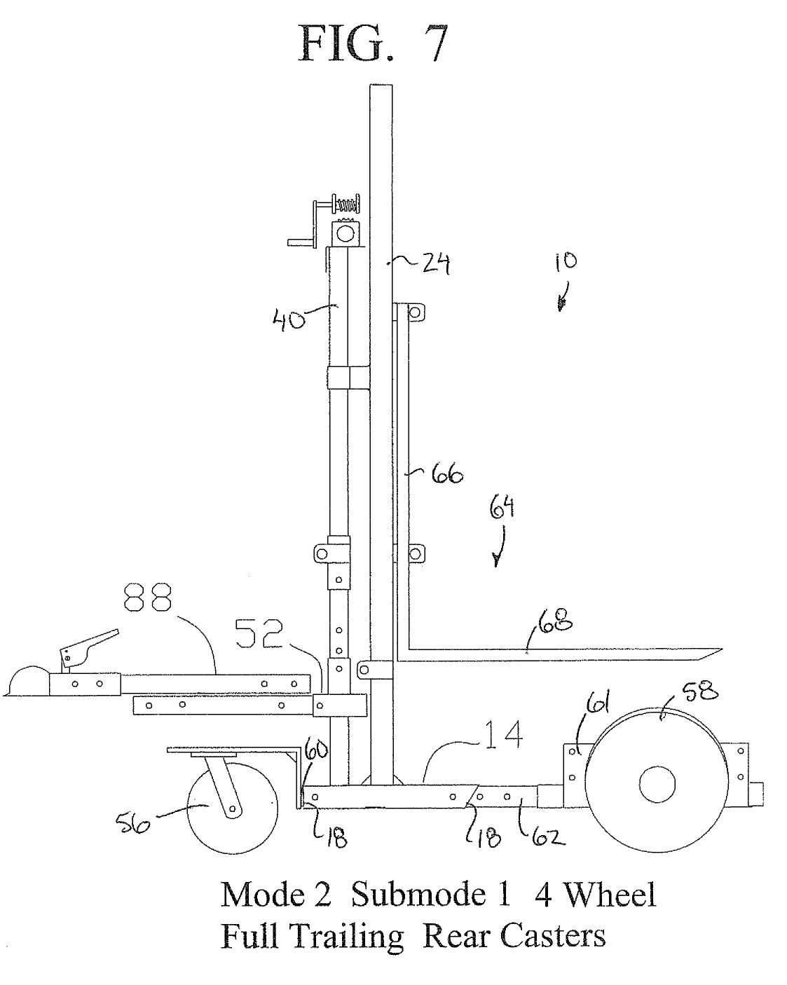

The following FIGS. 7 through 11B inclusive are embodiments wherein a separate motorized vehicle e.g. automobile provides the motive power. The manual worm gear winch drive is disengaged as the electric winch can be powered by the vehicle battery with a remote control within reach of operator.

Turning now to FIG. 7 a further embodiment is illustrated in which the wheels are similarly arranged to the configuration of FIGS. 1 through 4 by locating wheels of fixed orientation forwardly of the uprights on extension members with caster wheels rearward of both tubes 14 of the base. In this instance a hitch member 88 can be mounted in the mounting sleeve 54 on the upright 40 to project rearwardly from the plane of the uprights opposite the lift forks of the lift carriage.

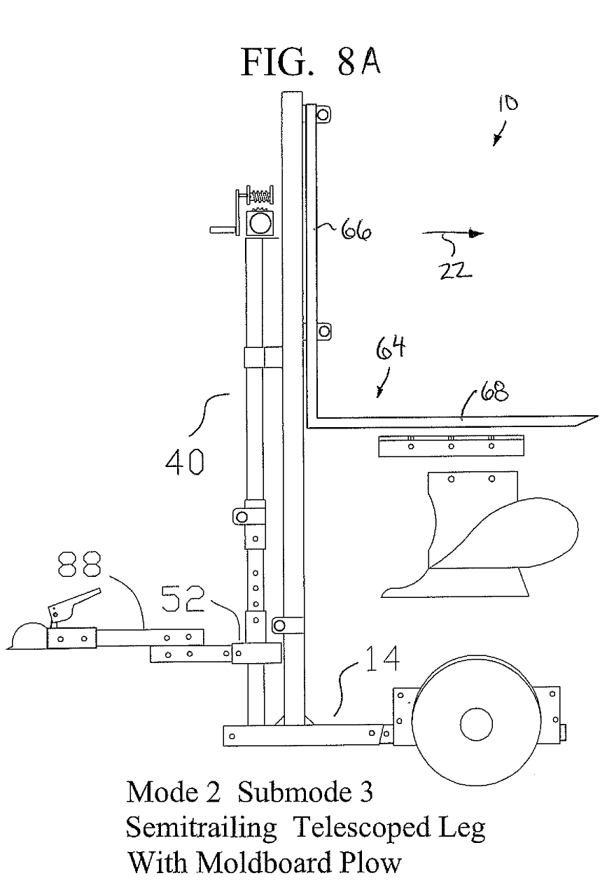

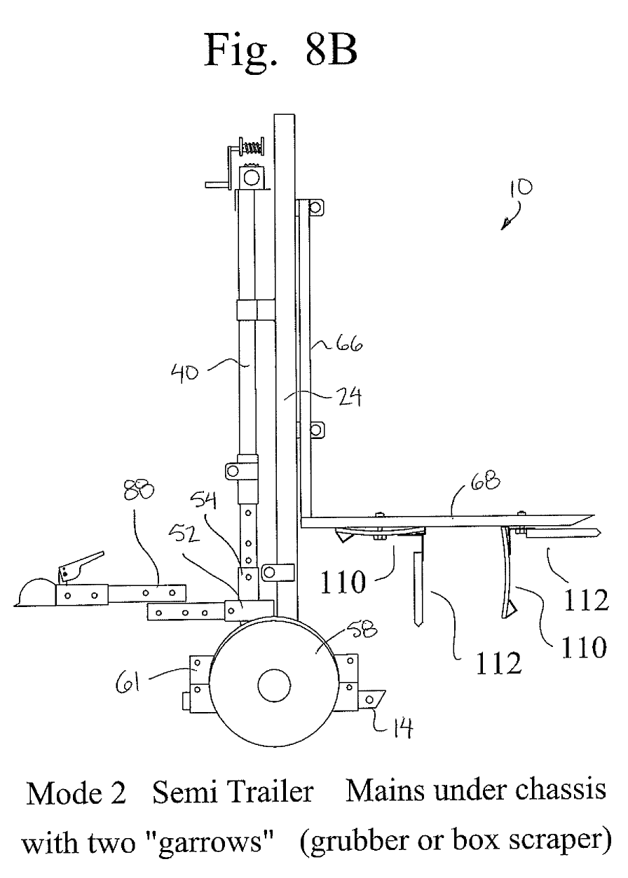

Turning to FIG. 8A, a further configuration is illustrated in which the caster wheels are removed from the rear ends of both tubes 14 of the base with only wheels of fixed orientation being mounted on extension members telescopically received in the front ends of the respective tubes of the base. The hitch member 88 is again mounted in the mounting sleeve 52 on the auxiliary support 40 to project rearward from the plane of the uprights opposite the lift carriage and the wheels of fixed orientation. When supported on a towing vehicle, part of the frame is carried on the wheels at the front ends of the telescoping members of the base while a rearward portion of the assembly is supported on the hitch member. In the embodiment of FIG. 8, a mouldboard plowshare (for example) is mounted to the lift forks directly by a suitable angle bracket adapter having mounting apertures therein for securing the mouldboard plowshare to the mounting apertures in the horizontal tines of the lift forks.

In this instance, the lift actuator may be provided with a looped cable running over top and bottom pulleys to apply downward as well as lift force and additional ballast may be added onto lift members if desired. Many other tool bits of this class (draft type surface or subsoiler) can be arrayed singly or in multiples in this manner.

FIG. 8B is a related semi-trailing version but with leg members removed. In this configuration two wheels of fixed orientation are supported on the two tubes 14 of the base respectively for rolling movement in the longitudinal direction. The hitch member 88 is supported in the mounting sleeve 52 on the vertical support 40 to project rearwardly from the plane of the uprights, opposite the lift forks on the lift carriage. A novel implement is shown mounted on the lift forks using fasteners extending through the mounting apertures therein. A scraper blade 110 is provided for spanning laterally between the two lift forks. A right angle bracket is mounted to the rear face of the scraper blade for locating fastener apertures therein to secure the scraper blade in a generally upright orientation spanning laterally between the two lift forks to depend from the lift forks. The flange mounts a plurality of harrow tines 112 at spaced positions therealong to be oriented to project rearwardly from the rear face of the scraper blade 110 so as to be oriented generally perpendicularly thereto. Accordingly when the scraper blade is mounted in an upright orientation, the harrow tines project forwardly in a generally horizontal orientation in the forward direction of the lift forks when the scraper blade faces rearwardly in the direction of the hitch member towards the towing vehicle. Alternatively, the scraper blade could be mounted in a generally horizontal configuration to the underside of the lift forks in which instance the harrow tines extend generally downward in an upright orientation. Positioning of the lift carriage along the uprights positions the height and degree of engagement of the tines or the scraper blade with the ground. As illustrated, two implements of similar configuration are shown mounted on the lift forks in the two different orientations so that in one instance the scraper blade is horizontal and the tines are vertical whereas in the other instance the scraper blade is vertical and the tines are generally horizontal. Thus the implement carrier can support the operation of other dual purpose implements built in the same fashion as this example where two different tool bars are fixed at a right angle to a heavy steel angle “backbone”

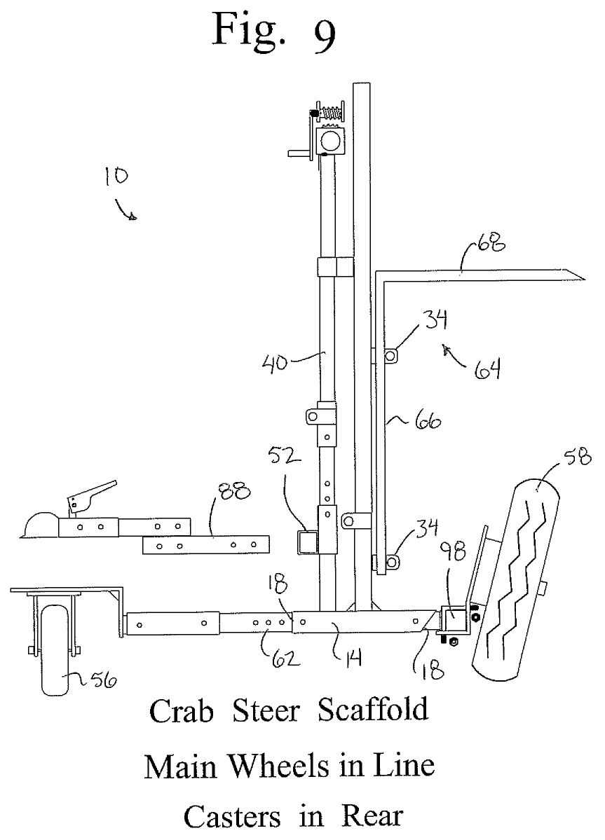

FIG. 9 is another lateral travel scaffold version different from the previous in that the extensible leg members are installed from rear of chassis. It may be pushed or pulled about by a separate motor vehicle by means of the tow tongue (shown here in side view for clarity) but said tow tongue 88 and its receiver sleeve 52 are turned 90 degrees for proper orientation for practice.

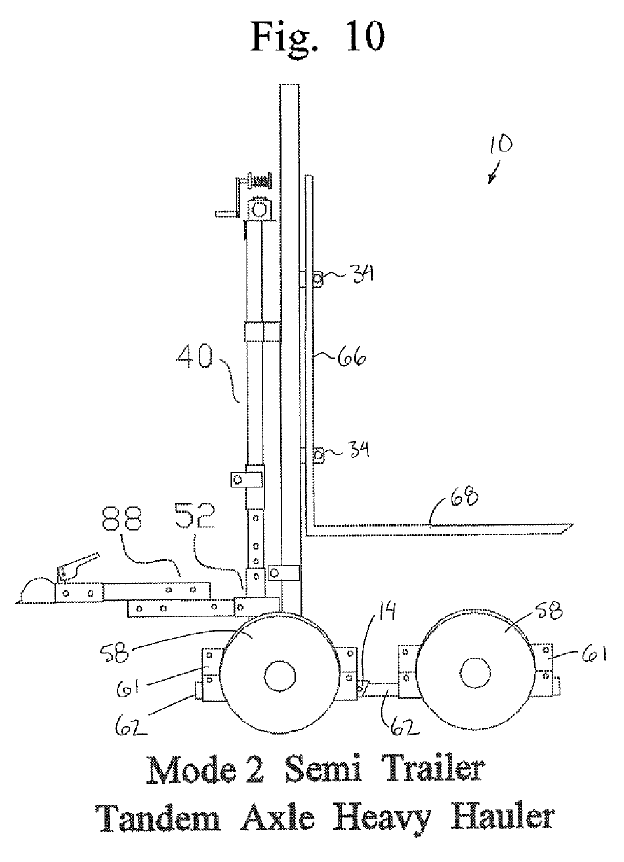

Turning now to FIG. 10, a further configuration is illustrated in which tandem wheels of fixed orientation are mounted spaced longitudinally along both laterally opposed sides of the frame so that a first wheel of fixed orientation is mounted on each of the tubes 14 of the base and a second wheel of fixed orientation is mounted on an extension member telescoping forward from the tubes in the same direction as the lift forks projecting from the lift carriage. A hitch member 88 is again received in the horizontal mounting sleeve 52 on the vertical auxiliary support 40 for connection to a towing vehicle. With the booster bar bridging the space between the tandem wheel supports and heavily loaded forks resting atop it, this configuration cancels the cantilevered fork load (bending moment) on both the forks and the legs.

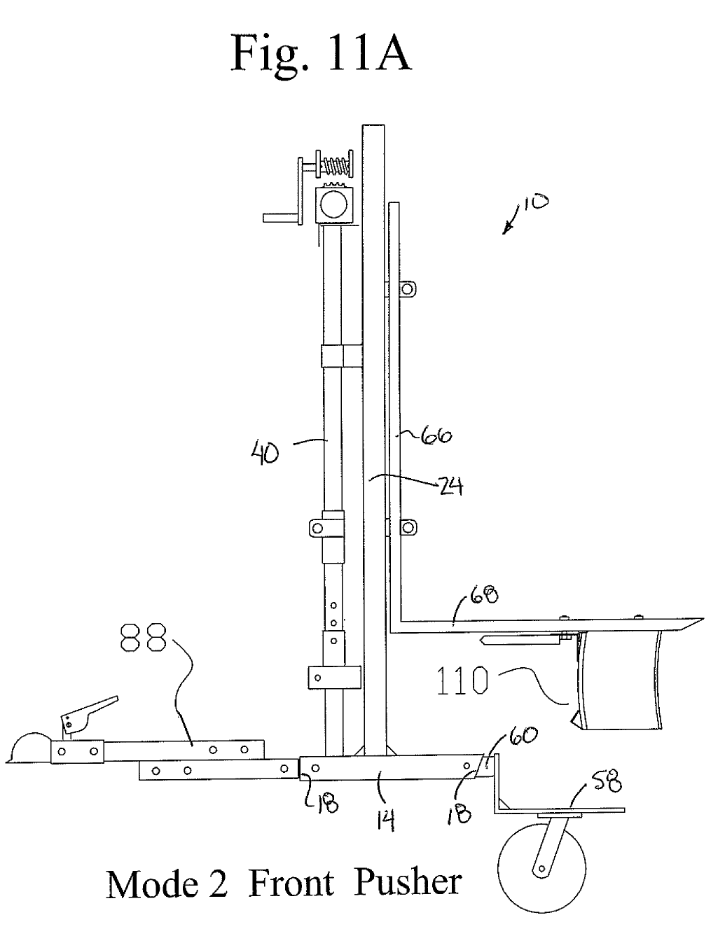

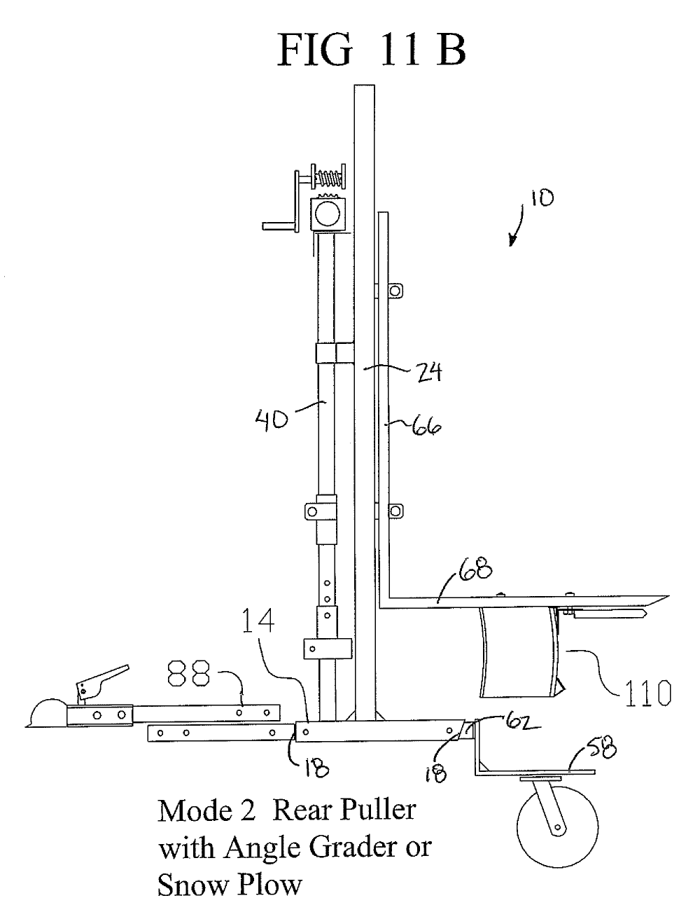

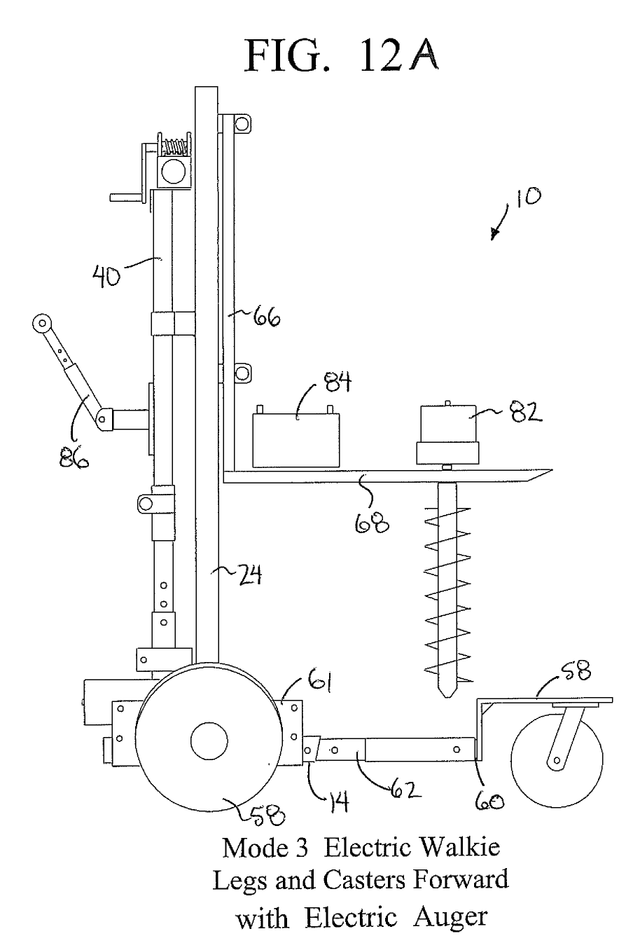

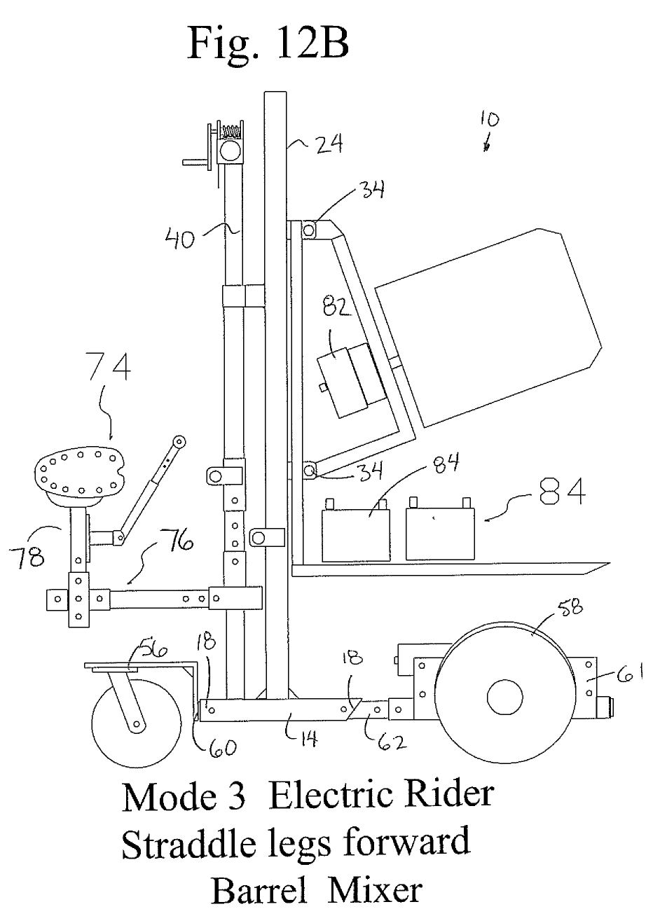

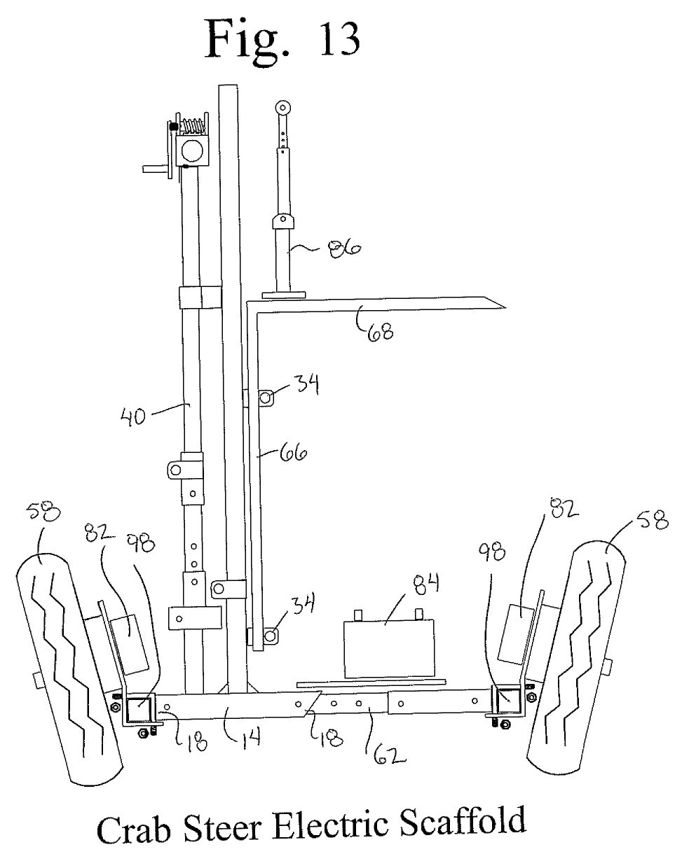

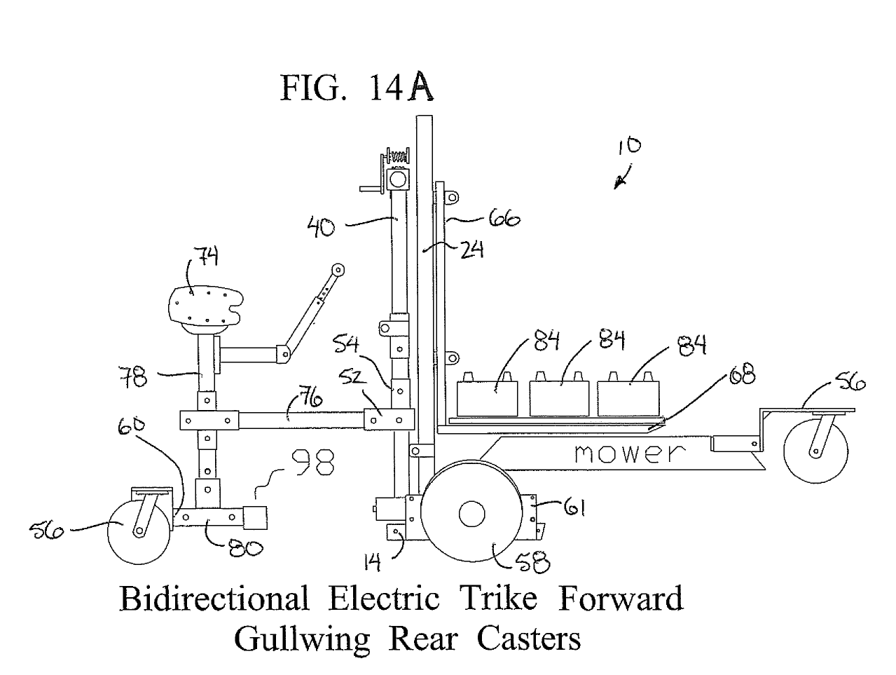

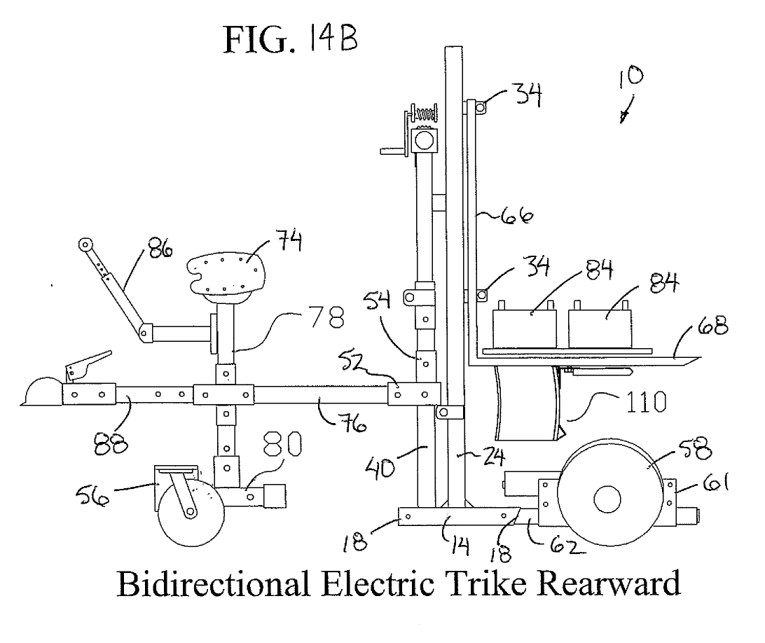

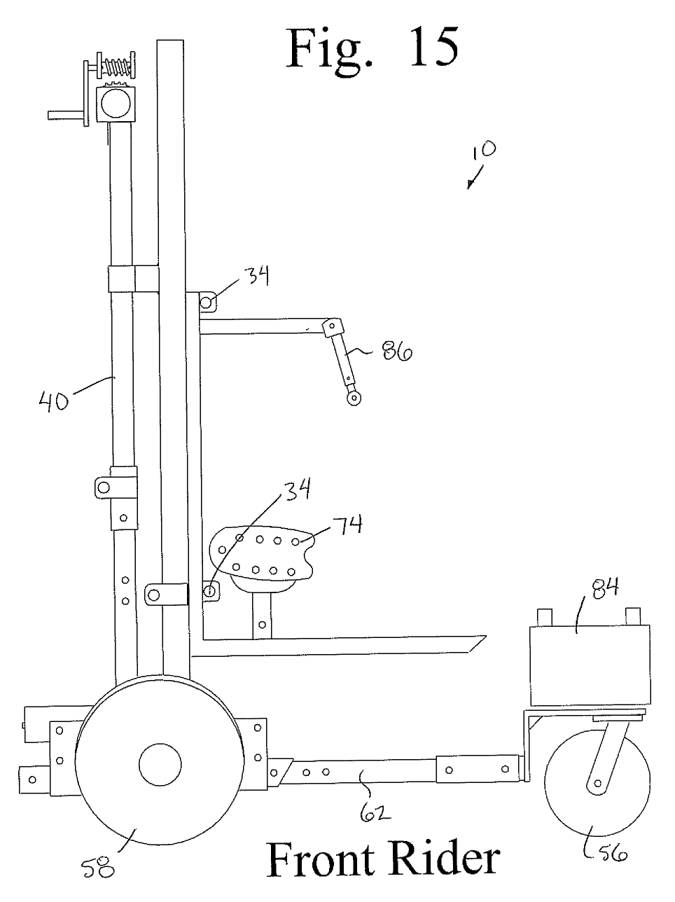

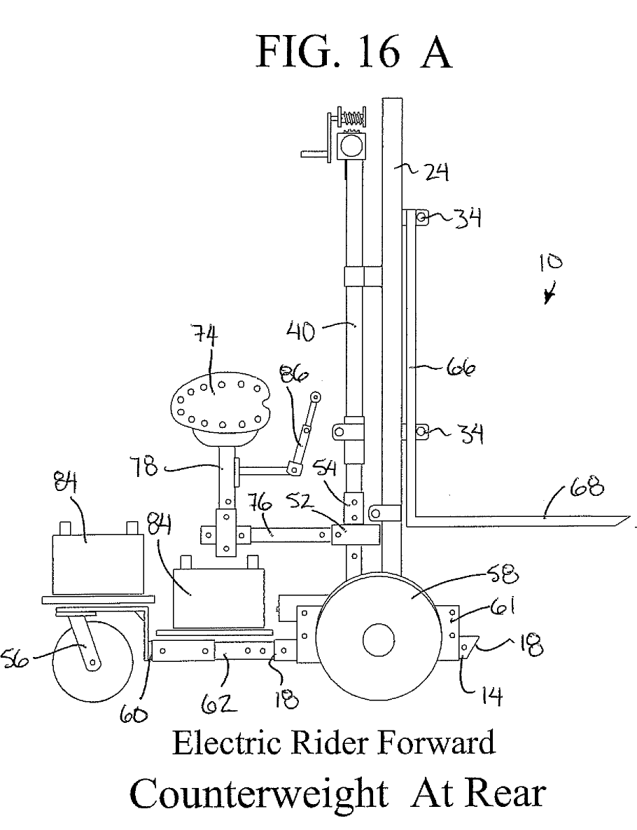

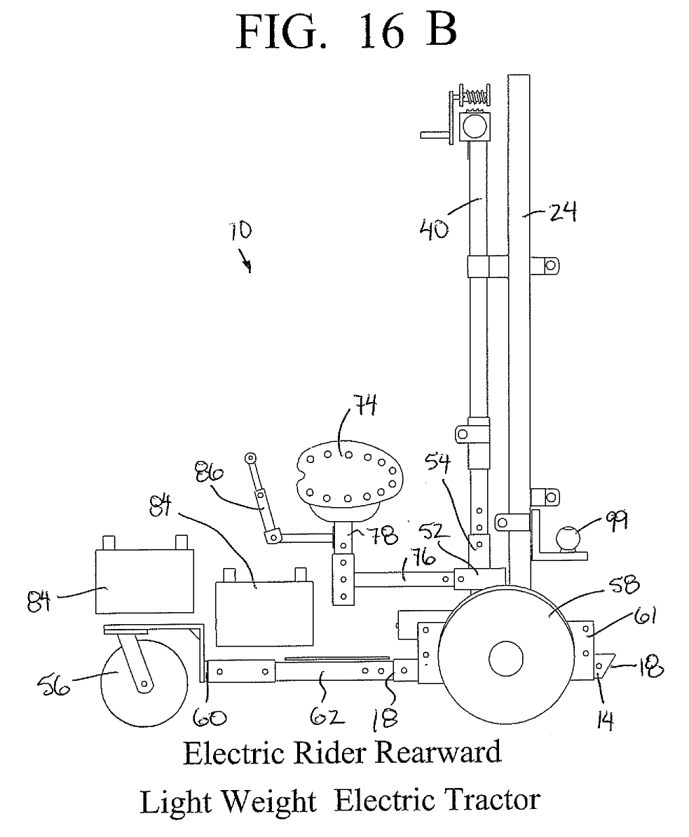

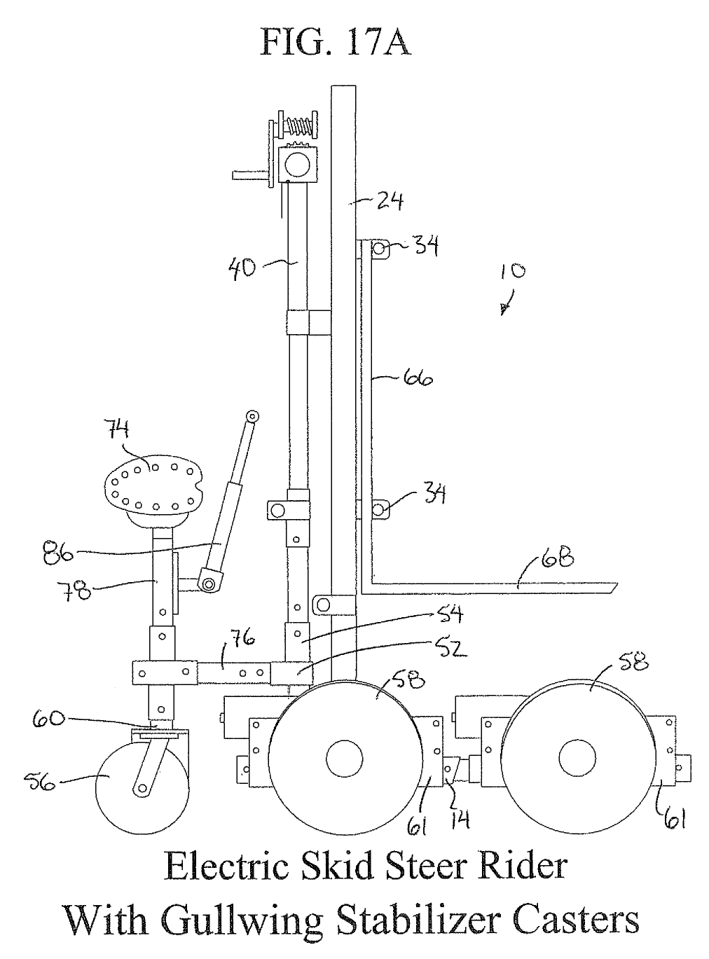

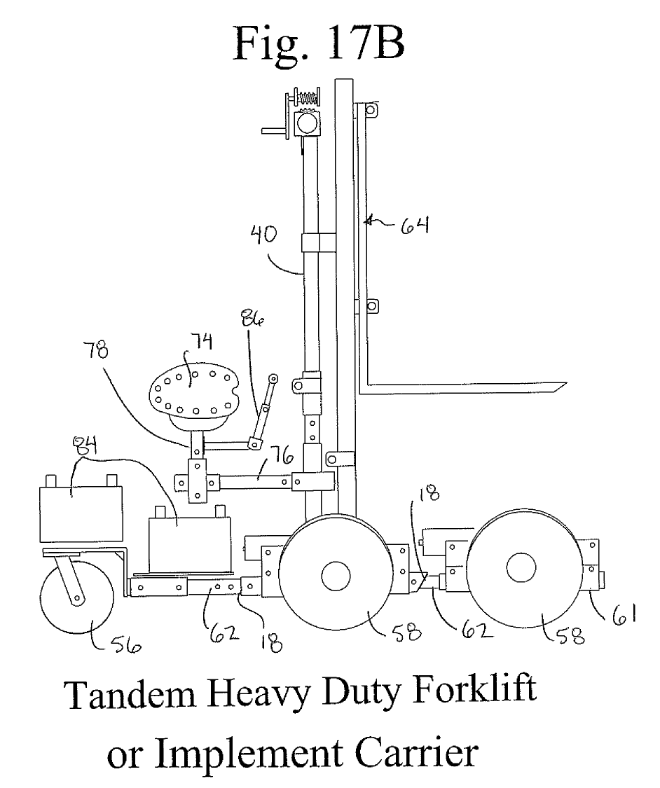

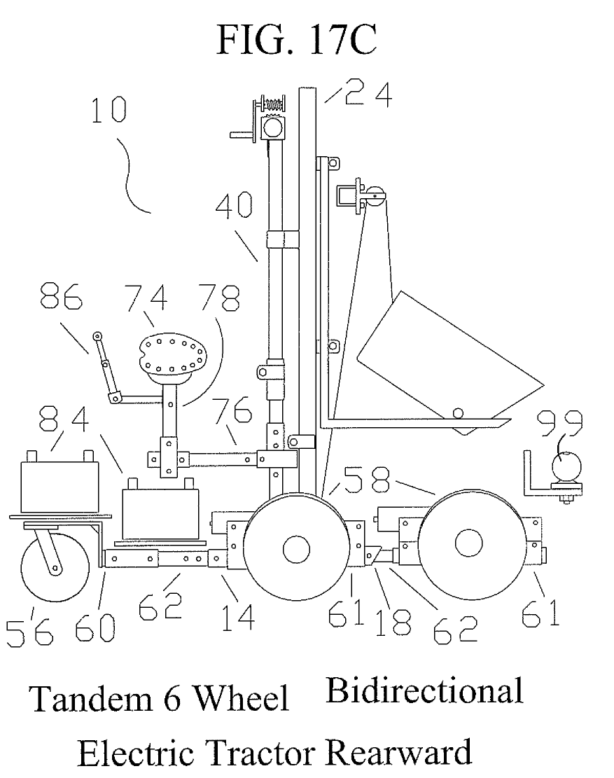

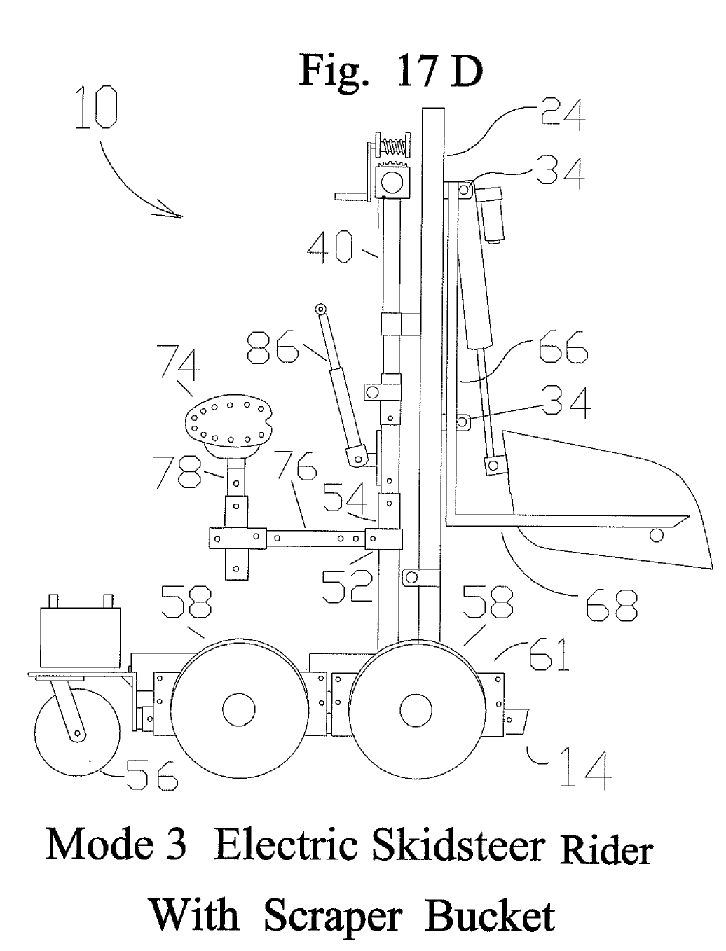

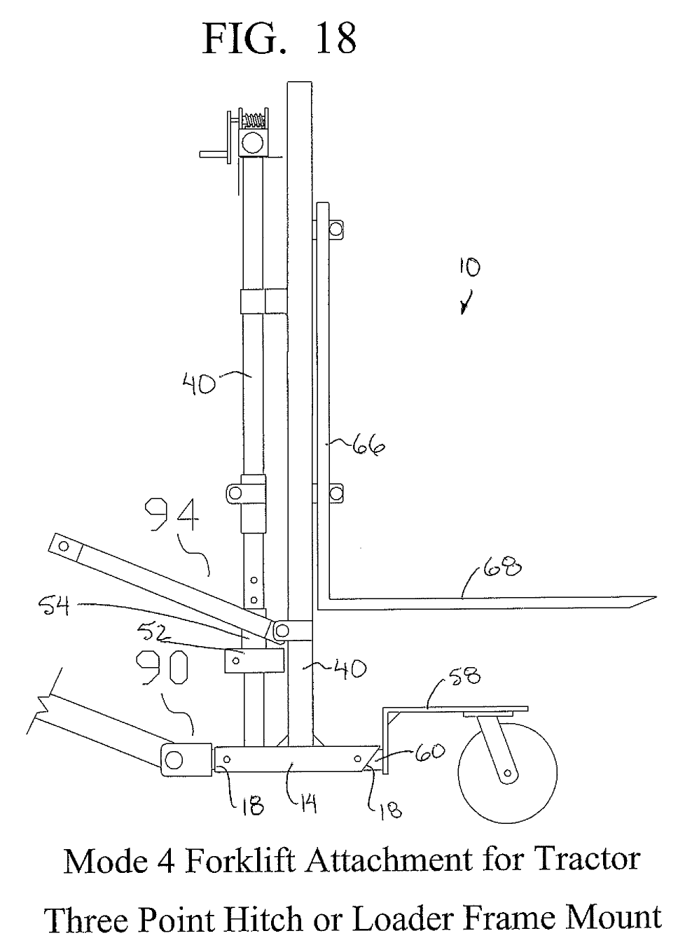

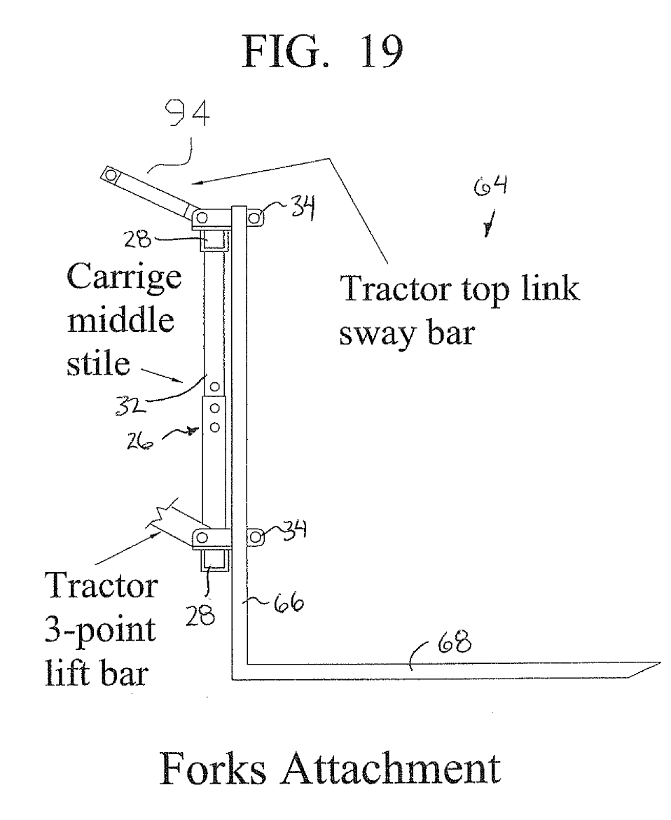

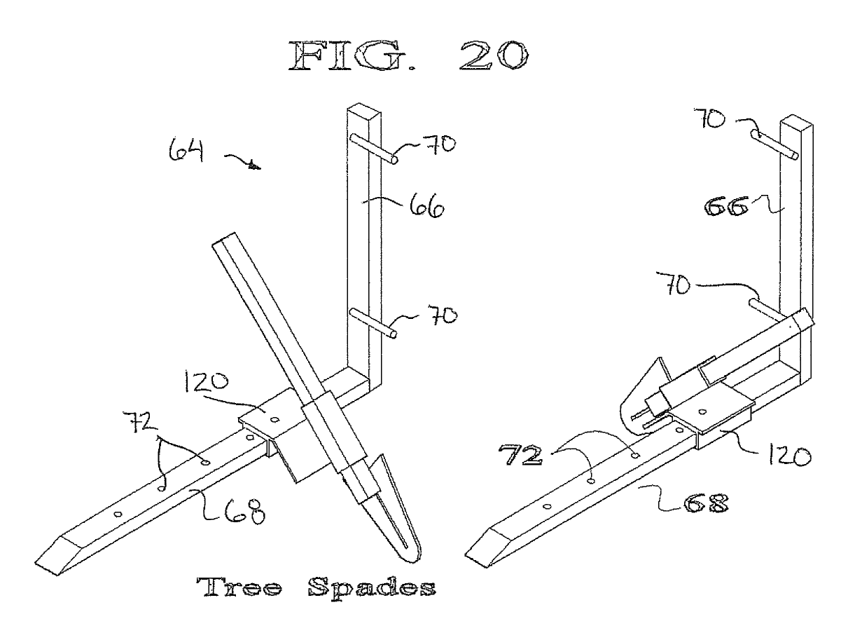

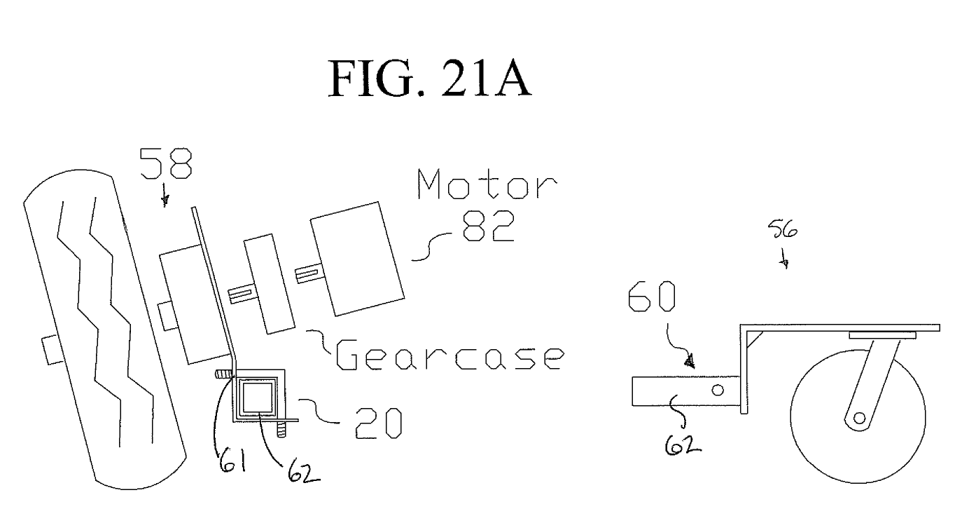

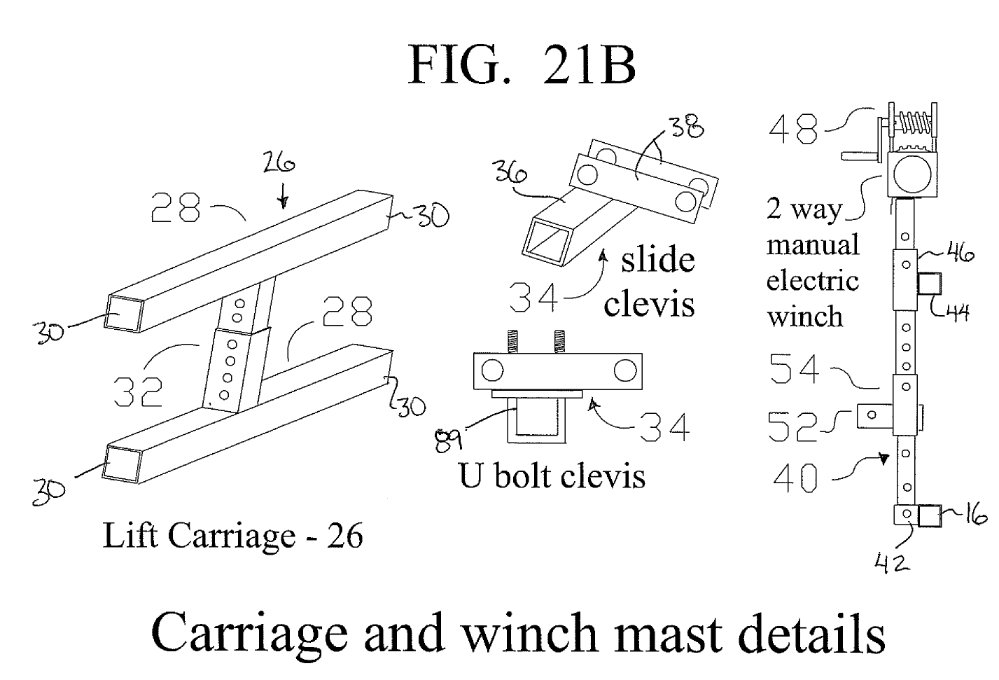

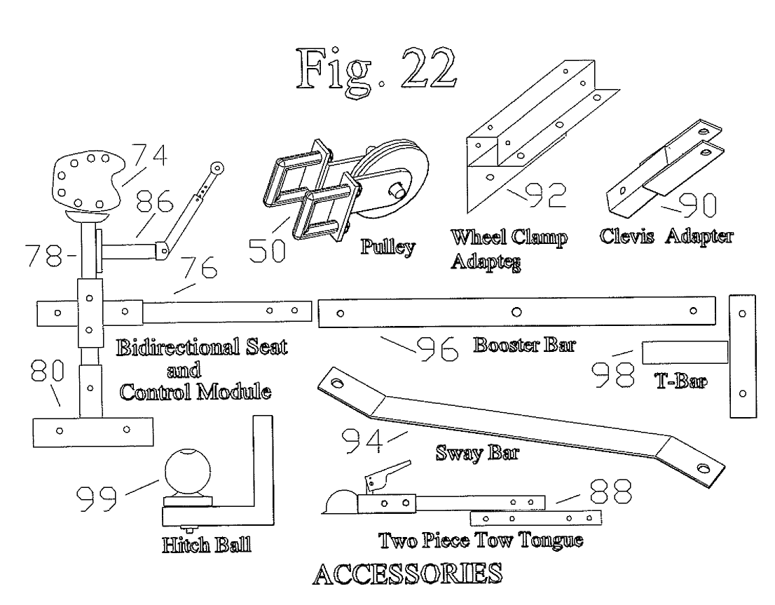

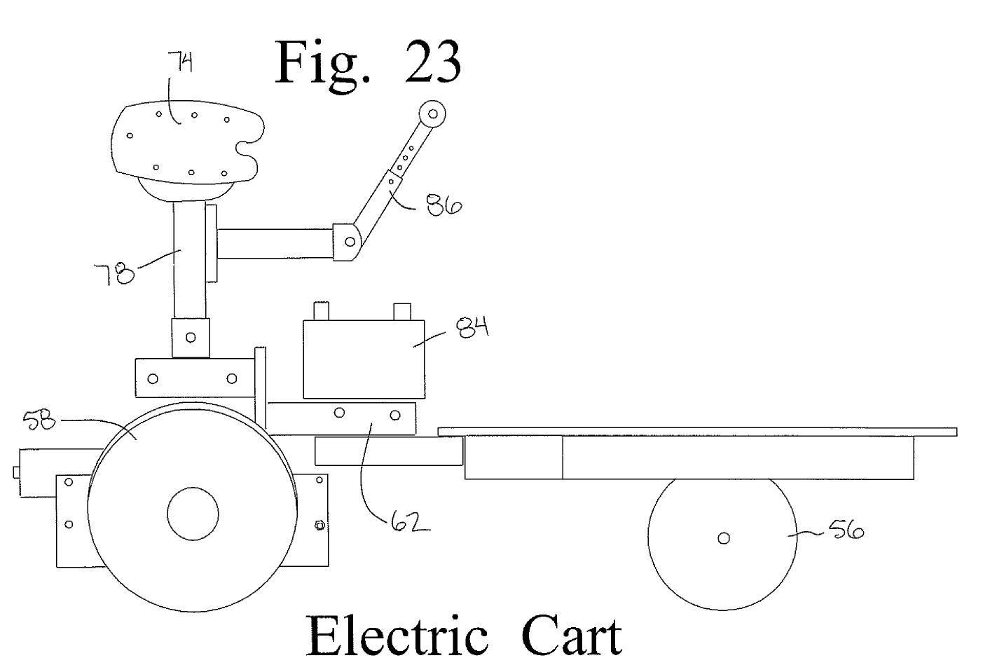

In further configuration shown in FIGS. 11A two hitch members 88 are telescopically received within the open ends of respective ones of the tubes 14 of the base frame at the rear end thereof to project rearwardly opposite the forwardly projecting lift forks of the lift carriage. When desired for use as a pusher dozer or snow plow, the scraper blade 110 noted above can be mounted to the lift forks to face forwardly at a desired angle about the vertical axis while caster wheels are mounted by wheel mounts 20 to the open front ends of both tubes 14 of the base with the scraper blade being located farther forward towards the free ends of the lift forks to be located ahead of the caster wheels. Two hitch ball accessories 99 on their support brackets are attached to the front bumper of the pusher vehicle to receive the hitch tubes 88 attachment.

A related variant of this direct steering rigid attachment (FIG. 11B) is pulled behind the motor vehicle instead. The implement is oriented facing rearward or in the same direction as puller vehicle.

The caster brackets 20 of caster wheels 56 may be turned upside down so as to more closely match the height of implement carrier to the respective vehicle bumpers.

The grader blade implement example shown can be tilted through an angle (for slope grading, trenching, etc.) by inserting shims or spacers under one of the lift members.

The following FIGS. 12 through 17D illustrate some of the possible electric self propelled configurations in the (self propelled battery electric) mode.

The flexibility in the battery electric configurations is greatly enhanced by the fact that power connections are made through flexible electric cables rather than through complex rigid mechanical means.

All are controlled by an operator's control column that can have individual variable speed and reverse control for each motor or paired connected group and for lift actuators and implements.

Most configurations can have a bidirectional rearward direction of travel as well as a reversing direction.

At least one and up to four wheels of fixed orientation are driven by electric “gearmotors”. Two types are shown; conventional angle drive “gearmotor” type attached to mounting wings and the new version of a preferred electric power take off module each consisting of an electric motor with or without an attached speed reduction gearcase which inserts into the recess of the wheel hubs. These wheel modules can be and are shown inclined outwards to lessen obstruction to other neighbouring components in the various configurations. Other drives such as chain and sprocket are possible.

A “zero turn radius” form of steering can be effected by individual differential control of speed and torque of powered wheel motors by the operator's control column. Other forms of steering such as manual mechanical systems can be incorporated.

The batteries can be distributed anywhere on the frame to gain advantage in weight distribution, traction, balance, stability, etc. but when massed atop forks they can be quickly changed in a drive in-drive out exchange manoeuvre.

The implements shown throughout drawing set are only typical examples; any 3 point hitch type or one modified for attachment to the carriage or forks can be served.

The drawings do not show the control and power cables and the motor controller (the pulse width modulator voltage controller) that is common to larger D.C. motors.

The electric two way winches (reversible motors) have the factory equipped 12 volt motors rather than the possible electric PTOs but regardless are operated through an on board electronic controller for variable speed forward and reverse and their manual worm drives are shown raised out of engagement.

FIG. 12A is a pedestrian configuration suitable for light implements. The powered wheels are driven by gearmotors such as the earth auger shown which itself is driven by the electric PTO module. The auger in this instance is fastened to the free ends of the lift forks which also carry a plurality of battery modules 84 thereon. In this example, wheels of fixed orientation are preferably mounted directly onto both of the tubes 14 of the base frame in approximate alignment with the uprights in the longitudinal direction, while extension members are used to mount additional mounts 20 spaced forwardly from the frame of the uprights. A walk behind frame is illustrated in which the wheels at the forward ends of the telescoping members comprise only caster wheels and the operator's control column module is mounted directly onto the vertical support 40 to control a motor module on the wheels of fixed orientation which are clamped directly onto the tubes 14 of the base frame.

In the configuration of FIG. 12B, a barrel mixer for e.g. concrete with a three-point hitch attachment is secured to the clevis mounts arranged at a three-point hitch spacing on the lift carriage. The lift forks are also mounted on the lift carriage on the same or a second set of mount devises to support a plurality of the battery pack modules 84 for driving rotation of the concrete mixture. The batteries may also be used to drive rotation of motor modules mounted on respective ones of the wheels of the base. With the large mass of a concrete mixer projected forwardly from the plane of the uprights, larger wheels of fixed orientation are preferably located on extension members projecting telescopically from the front ends of the tubes 14 of the base frame so that the wheels are located approximately beneath the concrete mixer. Caster wheels can be inserted into the rear ends of the two tubes 14 of the base frame directly below a seat assembly including the leg member or seat boom 76, the seat post 78 and the seat 74 supported thereon with the operator's control column module 86 for controlling the motors of the wheels and of the mixer.

FIG. 13 is a side elevational view of the assembled implement carrier in a mobile (side travel) steerable scaffold mode. The configuration is shown with main wheels powered by the preferred electric PTO modules inside the wheel hubs.

As shown in the configuration of FIG. 14A, the implement may comprise a lawn mower deck which is fastened below the lift forks to be suspended above the ground by the lift carriage at an inner end while additional caster wheels are supported at a free outer end of the deck of the mower. Battery modules to drive the mower, ground drive and lift actuator may be carried on a platform or container on forks for quick exchange at the charging station as electric energy demands in this case are high. Additional batteries for ground drive and lift actuator can be placed in the rear for counterbalance. Wheels of fixed orientation driven by motor modules can be clamped directly onto the two tubes 14 in this instance to allow additional clearance from obstruction to aas the mower deck example is too wide implement while the seat is positioned rearwardly from the plane of the uprights, opposite the mower deck, by a suitable leg member 76 received in the mounting sleeve 52 on the frame. An additional caster wheel, or a pair in a “gullwing” assembly using a T bar 98, is/are installed in a mount sleeve below the seat post. An additional T bar 98 mounted forward of the seat post offers a footrest.

Turning now to the configuration of FIG. 14B, essentially the rearward travelling variant of tricycle wheel gear mode similar to FIG. 14A, the lift forks are again used to support an implement suitable for pulling in the rearward direction directly thereon of the type comprising a scraper blade 110 as described above. Batteries for driving rolling movement of the wheels are also preferably carried on the deck formed by the lift forks of the lift carriage for weight and traction advantage. In this example, wheels of fixed orientation driven by motor modules can be located alternatively on forwardly telescoping extension members projecting from the two tubes 14 of the base respectively (if the implement is narrower than frame) while support for rolling movement at the rear end of the assembly is provided by caster wheels received within the auxiliary mounting sleeve 80 mounted at the bottom of the seat post 78 supported on the leg member projecting rearward from the mounting sleeve 52 on the vertical support 40 of the frame. The seat and operator's control column module are again mounted on the seat post as in previous embodiments, but are instead oriented to face the rearward direction of travel from the plane of the uprights opposite the forwardly projecting lift forks contrary to previous embodiments. This adds the advantage of better visibility and in some circumstances such as spraying, allows operator to face away from dust or noxious spray etc. In this direction a towing assist tongue can be added to the assembly. (Spray tank can be supported on a platform atop the legs for stability).

FIG. 15 is a side elevational view of the assembled implement carrier in an electrically powered 4 wheel forward seated rider configuration. It may suit gardening or orchard row crop tasks as operator can have produce baskets within reach and can be elevated to variable heights. A similar but bidirectional rearward variant is not shown.

Turning now to FIG. 16A a configuration similar to a conventional rider forklift is illustrated in which the forwardly projecting lift forks are counter balanced by telescoping extension members projecting rearward from the two tubes 14 of the base frame to locate caster wheels at the rear ends thereof spaced rearwardly from the plane of the uprights. Wheels of fixed orientation are preferably clamped directly to the tubes 14 of the base frame at laterally opposed sides and driven by motor modules which receive power from a battery module supported on the caster wheels at the rear of the assembly again for counter balancing the forwardly projecting lift forks. The seat assembly including the seat boom seat post and seat with control module can again be supported to project rearwardly from the mounting sleeve 52 on the upright vertical support 40 of the frame. An additional platform can straddle the rear legs to support more counterweight i.e. batteries, passengers, toolboxes etc.

The configuration of 16B is a reversal of the operator's control station to the rearward direction of travel. The forks are replaced with a hitchball on a bracket to turn it into the lighter duty electric tractor configuration with an elevating hitch.

The embodiments of FIGS. 17A, 17B, 17C, and 17D, having 4 powered traction wheels in tandem the increased weight capacity, tractive force, stability, flotation and greater sustained electrical power output, are more suitable for higher task performance.

FIG. 17A illustrates an electric rider skid steer forklift. The front and rear pairs of powered traction wheels can be attached within a range of fore and aft positions and casters can be used mounted anywhere in the rear to add further stability. A walking or standing operator configuration (not shown) is also possible.

In FIG. 17B a six wheel forward rider configuration is shown also but unlike the previous version in 17A, the two casters and legs in the rear form a rear deck or platform support for added stability and cargo capacity. In this instance, a set of four wheels of fixed orientation with respective motor modules are preferably mounted onto the base to be located clamped directly onto both tubes 14 of the base and onto forwardly projecting telescoping extensions extending from both tubes 14 of the base frame. A suitable deck formed of two other extension members extending rearward from the tubes 14 may again be provided for supporting the battery modules or cargo/passengers thereon. The embodiment may also find occasional use in the forward direction as a trailer dolly around a parking lot; a trailer hitch ball mounted on forks offers an elevating hitch for this purpose.

The embodiment of FIG. 17C is the heavier duty utility vehicle with a dump body or tractor version which is derived from the previous 17B by turning the seat post with attached operator's control to face the rearward direction of travel. The power enhancement can be both electrical (more batteries) and mechanical power because the embodiment of FIG. 17C has double the sustained mechanical tractive force with four motors. The hitch ball 99 shown detached may be attached onto the forks for an elevating hitch feature or straddling atop the forward facing legs to leave forks free. Alternatively a dump body as shown may be mounted on forks and a simple option for dump action can be effected by a pulley and cable system is shown.

FIG. 17D is a side elevational view of the assembled implement carrier somewhat similar to the version of 17B but with the front pair of power wheels moved to the rear facing set of legs. An earth scraper bucket as shown makes this into the “front end loader” embodiment.

The configuration of FIG. 18 is a forklift attachment only for a carrier vehicle other than the implement carrier. The clevis adapters 90 received respectively in the rear ends of the tubes 14 of the base are clamped onto the uprights respectively for connection to either the tractor 3 point hitch top link or the anti-sway bars 94 pivotally coupled thereto so that the assembled frame is arranged for mounting directly onto a three point hitch (example shown) or the front end loader frame of a conventional tractor or perhaps the front or rear bumper of a truck or other carrying vehicle (with suitable brackets). In this instance the assembled frame can be fully supported on the chassis of the carrying vehicle or caster wheels may be provided in the opposing front ends of the two tubes 14 for partially supporting the assembled frame for rolling movement along the ground. When supported entirely on the vehicle chassis, operation of the lift actuator to displace the lift carriage along the uprights also causes the lift carriage to be lifted and lowered in relation to the chassis of the vehicle.

As shown in FIG. 19, the lift carriage including the lift forks connected thereto can be detached from the uprights and connected directly to the three point hitch of a tractor. Similarly the three-point hitch arrangement or adjustability of the implement mounts on the lift carriage permit any number of mounted implements to be supported thereon. This forks attachment can also be adapted to other carrier vehicle apparatus such as the loader frame of a tractor or the snow plow lift frame of a pickup truck.

As shown in FIG. 20, implements may also be mounted on the lift forks by use of fork sleeves 120 which are arranged for close sliding engagement along the length of the lift members of each fork. Cooperating apertures are provided in the fork sleeves and in the lift members of the forks for selectively retaining the sleeves at a desired set position. In the illustrated example, the implements supported directly on the fork sleeve comprise tree spades in which an auxiliary mounting sleeve 122 is fixedly mounted onto the fork sleeves 120 so that the two mounting sleeves 122 project downwardly and inwardly towards one another when the fork sleeves are slidably supported along the length of the lift members of the forks. Elongate stems 124 are mounted for sliding movement in the direction of the mounting sleeves 122 with spade attachments 126 being mounted at the lower free ends of the stems 124. The spade attachments are thus arranged to project downwardly and inwardly towards one another for engaging beneath opposing sides of a tree to be spaded.

FIG. 23 shows a possible alternate use for the subset of modular components comprising the Battery Electric System representing one of many possible ways that a common towed trailer or cart can be converted to a rider type self propelled vehicle. Other modular components can find application elsewhere as well.

Referring now again to the kit in a general summary the “assembly kit” approach to mechanical equipment described herein refers mostly in this case but scaling is not limited to small consumer machinery of landscaping and construction and “short line” farm equipment of the drawn or on board mounted attachment type. It can be scaled to sizes to correspond to 3 point hitch implements of from Category 0 small to any larger size desired.

The following terms used herein are understood as follows:

A dependent implement is defined here as a machine that performs a particular task but depends upon another machine for its motive and auxiliary power and so must conjoin with an independent accommodating machine for its operation in this case the implement carrier invention noted.

By accommodation of a dependent implement is meant the attachment unto, receiving, retaining, transport, elevation, orientation, steering and control, provision of auxiliary power and such other support functions of the accommodated dependent implement in the performance of its intended task. This invention therefore is an extension in assembly kit form of the implement carrier concept into a number of different forms of a “prime mover” independent machine dedicated to the total support of other dependent implements and so a new classification of “dedicated implement carrier” is proposed. (The terms “tool carrier” “equipment carrier” and “attachment carrier” have less specific or distracting implications).

A “module” is defined here as “a self contained assembly of mechanical/electrical components that functions as a single unit and performs as part of a larger unit.” In this sense the main wheel module comprises the main wheel, hub, spindle, bearings, and the universal clamp on mounting bracket, the complete self contained assembly unit. The electric powered version or the “power wheel module” adds either of the described electric motor options; the gearmotor or the hub inserted electric power take off (motor, gearcase, and shaft drive adapter if required).

In its simplest form, the present invention may comprise a homebuilt manually propelled walkie (or pedestrian powered) forklift for outdoor use. Although indoor versions of such a “manual pallet stacker” are commonplace in industry, as are various other single purpose lifting and load transport devices, a dedicated design for both these functions (lift and transport) over improved outdoor terrain is somewhat rare; a seeming anomaly in the marketplace and conversion of any existing indoor example of pallet stacker was deemed impractical. In the course of this protracted design and construction of a suitable outdoor prototype, the original manual push outdoor forklift idea evolved into a substantially broadened new concept far beyond the original single mode single purpose material handling apparatus for the yard. It is now a unique forklift based generic multi mode multi function “universal” implement carrier in assembly kit form. The lifting forks from its origins as a pallet stacker are simply another dependent implement or task attachment but now double as mounting brackets for other implements as well.

The modular assemblies of the kit described herein, and other component details and accessories some of possible inventive merit, are listed following in this small equipment example. As the “core embodiment” of the invention in basic manual “walkie” or pedestrian powered mode is comprised of the same main components as the familiar manual pallet stacker of the warehouse industry (except as a quick assembly kit), only specialized and unique features will be detailed further herein.

The chassis, a rigid frame of at least one mast guide (two in drawings) with cross members forms the vertical track. An adjustable transverse mounting frame for the forks called the “carriage” travels vertically inside this guide track raised or lowered by a lift mechanism.

Upon its top and bottom rails is a unique feature, four or more universal implement mount devises (or tangs) that move about with laterally and rotationally adjustable motion. These “Quickclevises” or “Quicktangs” receive in releasable attachment the 3 point hitch stud pins of any implement (the lift forks are considered an implement as well) or the compatible mount brackets of others.

The devises or tangs are mounted on either sliding sleeves or U bolts for the sliding and rotatable connection to the top and bottom carriage rails.

A set of pallet forks defines various novel features. They attach onto the rail devises in the same manner as other 3 point hitch implements i.e. 3 point hitch stud pins attached to their vertical segments. Also there are holes in the horizontal tines for bolt connection of other implements attachable from above or below allowing them to double as implement mounting brackets.

Behind this assembly of frames is a vertical mast onto which are attached a lift mechanism, the middle cross bar of chassis, the sliding socket for the tow tongue accessory, and other accessory components.

A lift mechanism (winch, hydraulic cylinder, linear screw or lever jack etc.) may be either manually powered or electric but note that the lifting device selected in drawings is a unique winch combination; it embodies a manually cranked worm gear quick releasable attachment atop a standard electric winch with a d.c. electric motor that may be one of the PTO (power take off) modules of the assembly kit).

Another feature is a system of modular components for a power supply for mobility and attachment of auxiliary power. The battery electric one of self propelled Mode 3 described herein consists of battery power packs, a clamp on the operator's control column module and electric motors and speed reduction gearcases (as well as the standard requirement of connecting cables and electronic motor controllers.

The combination of an electric motor and a speed reduction gearcase is defined here as a PTO module. These PTO power modules power all electric driven implements through a universal compatible attachment system and when inserted into the hub of main (traction) wheels form in turn the self contained power wheel module.

Other features include:

The novel adaptations; conversions/reductions of existing 3 point or drawn implements i.e. the plowshare attachment.

Conversions /reductions of machines such as the earth auger conversion from a manual gas engine powered version.

Special implements designed specifically for the implement carrier such as the tree spade and “garrow” or grader/harrow combo.

Any number of existing 3 point hitch implements may be installed directly onto the quick attachment system of the carriage and are compatible with its other accessories.

Other implements can be adapted to fit directly onto forks (above or below) or carriage eliminating conventional 3 point hitch mounting frames.

The implements and their one universal implement carrier cover from:

homeowner yard chores such as lawn mower, snow blower, rototiller, and snow plow;

agricultural use such as plow, harrow, cultivator or other tool bar;

commercial landscaping use such as stump grinder, tree moving spade;

light construction such as pipe/cable laying plow, chain or other type trencher, earth auger, mobile barrel mixer (concrete etc.), grader, scaffold;

light industrial such as the pallet forks, mobile work platform/scaffold, tool/equipment carrier, mobile boom crane, auto lift, and shop waste dump bins themselves; and

many other items that can be rendered mobile by human or motorized vehicle tractive force and powered electrically.

Numerous other accessories for the kit include simple additions such as the hand cranked worm gear for the electric winch, the tow tongue, sulky seat, booster bar, stabilizer bars, over/undershot pulley, hitch ball bracket, wheel clamp adapters and possibly a hand crank drive for some implements such as the barrel mixer and earth auger.

Another class of accessories are the chassis transition adapters of the implement carrier itself such as the crab steer Tees, the angle brackets for connecting some implements to the forks, the clevis adapters, and the wheel mount adapters (clamp to insert tube mount).

A further class of adapters may be required to provide matching interfaces between motor or PTO modules and other implements.

Various advantages of the kit according to the present invention include:

1. Redundance, complexity, and cost are reduced with a single “common denominator” prime mover chassis in a multimode multifunction machine. Implements can now be reduced to their simplest essence often the tool bit(s) alone as other functions are now provided by the carrier machine.

2. Similarly, the various interchangeable adjustable quick attachable component modules easy convenient reconfiguring into different carrier versions each with its own particular advantage. The assembly kit invention can be a forklift, cart, scaffold, lift table, mobile jack or auto lift, trailer moving dolly, mobile crane as well as the versatile implement carrier.

3. In a dedicated multimode design, the most advantageous configuration can be selected for each implement in terms of performance, traction, balance, convenience, visibility for operator, etc. For instance the best location for a mower, snow blower or dozer is obviously up front. However a front pusher plow wouldn't work well nor would an operator want to face the noxious spray from a front mounted sprayer boom. Pushed trailers don't co-operate well but pusher mode for a trailer dolly is helpful. The significant weight of the batteries can be distributed anywhere for counterbalance, stability, and traction purposes and if massed onto a forks platform offers quick drive in-drive out exchange at the charging stand. This text and drawings show only a sampling of the possible configurations and functions of the implement carrier.

4. The established advantages of battery electric drives are well known but of particular benefit in a multi-configuration machine as they offer a greater flexibility in design for optimizing an electrically mobilized chassis described in the Mode 3 group of configurations described later. This is due mainly to the separation, relocation and recombination options available in having components and assembled drive units for mobility and implement operation connected only by flexible power cables, control wires, etc. Motors, gearcases, differentials, and power take off shaft drives need no more be in fixed mechanical arrangement. For example, power driven traction wheels can now be self contained motor and wheel modular units. Furthermore, this implement carrier invention allows all wheel module units to be attachable onto chassis base at various locations. This flexibility is the key to multi-configurable versatility and offers some unobstructed space for operated implements carried thereon, obvious efficiency improvement, redistribution of components for traction, balance etc. bidirectional operation and steering function through individual independent control over motor speed and torque.

5. It may also, in its electric propulsion modes, offer a further advance in the green shift to a more ecologically benign and sustainable energy form (renewable electricity) thus contributing to the reduction in the output of pollution emissions and greenhouse gases and dependence on fossil energy sources by internal combustion engine dependent lifestyles. Small equipment engines such as consumer lawn and garden tractors etc. have insignificant pollution control equipment to date.

6. It is a simple down to earth low technology machine some parts amenable even to homebuilding; many components can be improvised from salvage machinery and common steel stock and off the shelf hardware items. The implement carrier kit is quickly and easily assembled into its varied configurations or dismantled into its major components for transport.

A quick attachment feature is incorporated into the kit. As the versatility here is in the quick attachment, release, adjustment and interchangement of component modules, a number of strategies both common and innovative to this aim are listed:

The prototype's main frame members are built mainly of two related sizes of seamless square steel tubing, a nominal outside dimension insert tube which slides inside nominal similar but inside dimension sleeve tube. These provide the sliding, rotational and adjustment flexibility.

Some quick uniform standardized systems of attachment between different systems and components thereof, have been specially designed (Items 1, 2, 3, 4, 5, and 6 below) or adopted from existing common hardware (Item 7):

1. A simple length of right angle steel stock (angle iron) that can clamp onto any square tube by two or more L or U shaped bolts tentatively dubbed a “Quickclamp”. The “Quick” attachment features are defined in the drawings. A variation on this could be a flat strap or plate rather than the angle steel with U bolts for clamping. The main power wheel modules for instance attach by this unique “Quickclamp”, a device for quick easy attachment anywhere on any square tubing of chassis frame or legs etc.

2. For most fork mounted implements and even the battery packs one can also just drive into them to engage them.

3. A number of universal clevis members of metal straps (or tangs) atop a form of sliding, rotating detachable support bracket (which could be a sliding sleeve tube section or either the L or U bolt version of the “Quickclamp” (Item 1 above). They install on the top and bottom carriage rails and are dubbed “Quickclevis” forming an universal implement attachment interface accepting the standard 3 point hitch stud pins as well as other devices albeit in a rigid fashion. However, a conventional swing bar type 3 point hitch apparatus can be fitted and used as a rear mount or front mount hitch in the bidirectional electric modes.

4. Holes through chassis framing matching ones through the mating components for quick attachment and adjustment with “Quikpins” bent pins and retainers, bolts etc.

5. A series of holes in the horizontal fork tines for releasable attachment and adjustment of simple implement reductions. They turn the forks themselves into implement mount brackets.

6. A specially designed common mount dubbed “Quicklatch” to releasably interattach all the separate modules i.e. motors, gearcases, main (powered) wheels, power shaft adapters, the driven implement modules (and conforming alien ones) to each other in any required configuration or location for both mobility and auxiliary power.

7. A number of specially designed but very simple transition and conversion adapters. For example, a length of “sleeve tube” welded to a length of “Quickclamp” forms a transition adapter to allow casters to clamp mount (rather than their insert tube mounting) onto any 2 inch square tube. And a similar adapter from the round keyed shafts of motors and gearcases to an industry standard six spline PTO (or any other) shaft forms an electric power take off or hub drive for an alternate use in other electric vehicles.

8. Standard hardware items such as bent Quickpins, hairpins, threaded bolts, U and L shaped bolts, 3 point hitch stud pins, trailer hitch ball and coupler, Lovejoy shaft couplings etc. Many are not shown on drawings to prevent clutter as are any other items deemed obvious and of standard requirement such as the electric power and control conductors, electronic motor controllers, and some reinforcing, bracing and articulating members.

With regard to performance and use this coupling flexibility and multi configuration assembly allows this implement carrier invention to:

1. Accept various common power sources from the limited human force to motorized traction vehicle (in draft, push or carry on mounting) to on board self contained power.

2. Allow common existing tools and implements to be mounted for different tasks especially those simple ones of the 3 point hitch configuration. The forks which are also adapted to this industry standard are then just another task implement.

3. Allow new simplified design implements to be directly attached either to its carriage rails or its forks in either upright or upside down position either singly or in multiples as tandem or stacked arrays.

4. Allow alternate uses for its main component modules and systems thereof on alien independent apparatus such as table saws, air compressors, even vehicles etc. that have the compatible “Quicklatch” module attachment feature.

5. Allow the most advantageous configuration for each application of motive and auxiliary power to optimize balance, traction, maneuverability, convenience and performance efficiency.

In discussing the flexibility of the implement carrier assembly kit, the multiple operational configurations have been organized into modes, submodes, functions and alternate uses. Modes refer to the source of motive power from human effort to separate existing traction vehicle to on board self contained (e.g. battery electric) but they extend also to modes where a stripped down frame or lesser component is carried on another prime mover support vehicle. Submodes are variations of different modes with the same power source.

In each of these different mode and submode configurations from manual, towed, pushed and self propelled, the separate components can be placed at any location and are additional flexibility options to the mode selection ones for further customizing the tool carrier chassis in terms of weight distribution, balance, traction, maneuverability, convenience, and task implement requirements.

MODE 1, manually propelled or U push “walkie” mode. This is the basic mode wherein human force alone is used for mobility and sometimes tool operation. (FIGS. 1 thru 6B inclusive are such configured. It can function as a light duty carrier chassis for many light implements such as forks, dump bins, shop crane, mobile lift table, scaffold, manual tree spade, earth auger, barrel mixer etc. be they manual crank, battery electric, or however powered. Several practical variations (submodes) are possible as the straddle legs, the main wheels and the casters can all be moved about to different locations forward and aft and even turned sideways for crab steer submode. This mode can do duty as a conventional pallet stacker/light forklift, a light implement carrier for e.g. a soil auger or barrel mixer, trailer dolly, scaffold, mobile crane, etc.

The T shaped accessory brackets under chassis of some of the above modes would allow a transverse orientation to the main wheels for sideways or crab travel mode useful in scaffolding or narrow isle etc. special applications (FIG. 6).

MODE 2 external traction vehicle powered mode. (draft or pusher). A trailer hitch tongue accessory at rear of chassis allows attachment of any small powered vehicle with a trailer hitch ball front or rear. FIGS. 7 to 11B inclusive show some of the preferred submode examples including crab steer and direct steer types.

MODE 3 the self propelled mode (FIGS. 12 to 17D inclusive) uses an on-board power supply most commonly a battery electric system as described for mobility and auxiliary attachment drive.

The chassis can be configured similarly to many of the previously listed versions but a number of additional configurations becomes available.

From one to 4 of the main fixed wheels can be powered by electric motors in various forms of mechanical connection. Some examples shown herein are an early type angle drive gearmotor but a preferred design, the universal electric PTO (power take off) module, consisting of an axial flux motor coupled to a quick attachable reduction gearcase. It can be quick attached anywhere to power any component on the “Tultruk” modular system from lift actuators to implements but especially to the traction drive wheel modules as described in FIG. 21A as a portion of the new design power wheel modular assembly as it inserts neatly and compactly into the hub recesses.

The addition of a bidirectional (swiveling) operator's seat and operator's control column in the rear adds bidirectional flexibility to some of these rider versions. Casters can now be placed singly or in lateral pairs (gullwing) fashion or in tandem pairs below seat post for a more maneuverable “tricycle gear”.

Direction of operational travel in bidirectional modes is defined as always in that forward is still the direction forks do or would face. Rearward is the operational travel in the opposite direction. Reverse, when used on occasion as in other vehicles is defined as the direction opposite to normal travel operational direction as configured.

Legs and casters can be installed in the rear of frame and additional legs and main power wheels can be added to front.

Steering is by individual independent control of power wheel(s) on each side for “zero turn radius” and “differential torque” capability but pivoting mechanical systems can be devised.

A simple dump or implement tipping feature is easily rigged up with the cable pulley accessory attached to the top center of carriage. A length of separate cable or rope anchored at chassis bottom, strung over this “overshot” pulley and attached to the end of any implement. The same pulley attached at bottom of chassis can be rigged in reverse to apply downward winch force on carriage for the “hitchhiker transport mode” behind a truck or for down pressure on some implements.

The kit for assembly into a tool carrier has many functions. Functions (F1 to F8) are tasks performed by the implement carrier using a dependent tool or implement. They can be powered by any of the previously listed modes.

(F1). Conventional forklift for lifting/transporting anything that can be engaged thereon.

(F2). Forks upside down for high lift; a mobile scaffold, or mobile shop or yard crane etc.

(F3). 3 point hitch implement carrier, carriage mount. The forks are replaced here by an existing industry standard 3 point hitch implement with auxiliary power if necessary direct from electric motor or electric PTO module.

(F4). Direct to forks mount above or below the forks can be used as mounting brackets. Adapting an implement design to the Tultruk forks mount is often a reduction or simplification of most standard 3 point hitch implements. For instance the triangular mounting frame and boom of a 3 point hitch grader blade is not necessary; models of the grader blade shown in some drawings bolt directly under forks. Battery packs can attach above forks and changing one is therefore as easy and quick as picking up a pallet with a forklift. Conventional PTO shafts and gearboxes etc. for the finishing mower and soil auger shown and other reductions are also unnecessary as the electric motors can often drive directly at rated speed or thru the PTO module assemblies.

(F5) Combined tandem mount below forks. Bolting a separate tooth bar and grader blade in tandem on the long forks forms a makeshift grubber of a sort akin to the box scraper landscape device as shown in FIG. 8B. Other practical tandem tool or tool bar possibilities may exist.

(F6) Combined over/under implement mount from both above and below fork or direct to carriage and direct to forks combined mount. The 4 wheel conventional rider of FIG. 12B shows also that two implements, an electric barrel mixer (driven by the engineered motor/gearcase combo power module) and a set of forks can be mounted at the same time for a combined forks and other implement mount. Forks are then free to support batteries. The battery packs, controller, and control column can be clamped anywhere on chassis though. The trailer hitch ball accessory that turns Tultruk into a tractor or trailer dolly also can mount onto carriage or forks to offer an elevating hitch.

(F7) Direct onto forks using adapter brackets. In the case of plow type subsoiler implements (example in FIG. 8A) the reduction/simplification is further extended to just the tool bit(s), a vertical mounting shank, and an adapter bracket to match mounting holes of fork and tool bit. A towed configuration of the “Tultruk” provides all other necessary function from draft, elevation, depth control, orientation, transport etc.

(F8). Direct to carriage mount of custom bracket design implements.

The mounted and driven dependent implements shown in drawings are just representative examples of the class of spinoff implements showing some drastic reductions in complexity some to merely a tool bit bolted to forks; the result of having a single universal common denominator “prime mover” support chassis for all. A prime mover that puts the accommodation needs of said implements first and custom configures itself around these requirements.

The kit also has many alternate uses. This refers to the use of component modules, accessories etc. comprising the kit on other (alien) equipment taking advantage of the universal attachment features.

The unique manual/electric winch option used here for the implement carrier is mounted on a length of 2 inch square tubing pedestal for a purpose; it can now be inserted into an automobile trailer hitch (or any other) 2 inch square tube receiver sleeve on trailers, cranes etc.

The main wheels by virtue of their integral “Quickclamp” feature can install wherever a few inches of similar size square tubing presents itself for the purpose of clamping—wheelbarrow, wagon, small trailer frame, boxes, crates, platforms, whatever. In fact a trailer can be motorized by the “power dolly” into a spinoff implement such as in FIG. 23. With the complete battery electric modular kit on board, it becomes a self contained bidirectional power cart.

Clamping a power wheel module up on a mast and replacing wheel with a rope reel turns it into a makeshift rope wind winch called a “cathead” for operating a drop-hammer.

The electric motors alone or as PTO modules with their Quickattach gearcases can match speed, torque and power requirements for hydraulic pumps, table saws, air compressors, drill presses, lathes, etc. for a common universal power supply in workshops and jobsites.

Due to the inherent qualities of the electric modular system previously cited, there is no reason that the modular power system especially the battery pack based one and the power wheel units with their in-wheel motors cannot be used wholly or in part moved over to an electric car chassis for weekday commuting; then placed onto the implement carrier for weekend chores on Saturday. And Sundays; just attach some of these electric components to the ATV or boat outfit if all have common quick attachment systems such as these “Quickclamp” and “Quicklatch” type examples. So in some ways it may be possible to extend the modular assembly kit to other powered vehicles and machines besides the implement carrier. The “assembly kit” much more than just the original implement carrier frame. As long as all mating components have the uniform standardized attachment interfaces.

Needless to say, connecting an A.C. inverter to such an ample battery pack module provides a large mobile 110/220 volt A.C. emergency or alternate power supply for off grid or jobsite use.

The clevis adapter converts any sleeve tube to a clevis end.

The wheel clamp transition adapter converts the L bolt type Quickclamp to insert sleeve attachment system.

The transition wheel mount adapter shown in the accessories drawing FIG. 22 can “Quickclamp” onto any square tube of relevant size such as a trailer hitch tongue or cart etc. frame. The caster wheel can then similarly install therein (or elsewhere) in similar fashion.

The booster bar, with a clevis pin hole (or hitch ball) in the middle and 3 point hitch pins in the ends can do double duty as a 3 point hitch drawbar for small tractors. It normally is used for assembling a second or tandem axle for transporting heavy loads in the Tandem Heavy Hauler trailer mode (FIG. 9) or as a support bridge spanning legs.

A further detailed discussion of some drawings will now be discussed.

The invention has symmetry about the central longitudinal axis.

Components not specifically defined are deemed self evident.

Common hardware attachment devices such as bolts, pins, etc. are not shown to avoid clutter. Neither are some larger ones such as frame braces, swivel joints, power cables, electronic controllers, etc. if not material to novelty claims.

Various parts additional to basic rigid frame include:

The electric winch with the additional option—the manual worm drive attachment a useful add-on option for the manual (Mode 1) operation but also as a position holding restraint brake and for fine tuning depth control of some implements. This attachment is “quick attached” by means of a hinged or slotted bracket as it must be moved out of engagement to use the electric mode on winch. It is shown as a commercial unit powered by a 12 volt electric motor not the electric PTO module of this assembly kit.

A sliding top link attachment to a tractor 3 point hitch (Mode 4) and below that a sliding collar receiver tube for the tow tongue or the sulky seat boom are also shown lower on the winch mast.

At least two removable caster wheels are provided in which their insert tube universal mount allows them to be inserted at many sleeve tube locations on the implement carrier frame or on the wheel adapters.

At least two removable slideable legs. They consist of a suitable leg length of “insert tube” to insert and slide about inside receiver tubes in base frame with a section of sleeve tube at one end to allow attachment of a “Quickclamp” main wheel and insert mount type casters in several assembly ways.

At least two main wheel assemblies. There are two main requirements for these:

1. These self contained main wheel modules must be driven at times by an electric motor that is quick attached as an integral part of the wheel assembly to form a self contained power wheel module. Two design options are shown; the simple solution: a right angle drive gearmotor mounted directly on a wing or flange and the preferred proposed design; the electric power take off module inserted inside the hub recess.

2. These complete main wheel modules powered or not must quick attach at many locations on the implement carrier's several chassis configurations so a form of universal (clamp type) mount has been devised. As the basic frame and legs of this chassis example are essentially square steel tube, a length of steel angle with at least two L or U shaped bolts can clamp anywhere unto them so that is the quick clamping option chosen. The steel angle also incorporates a “mounting wing” or flange inclined slightly to increase clearance for an attached motor drive option installed thereon.

The main wheels in their preferred embodiment as mentioned above would have an inner recess to accommodate the engineered power unit of the future; the electric PTO module consisting of a d.c. pancake type (or axial flux) motor, and a pancake shaped quick attach planetary gearcase would fit at least partly inside recess. A shaft adapter would convert output to the common agricultural PTO type (one and three eighths inch diameter by six spline). Thus the main wheels would be considered driven implements for the electric PTOs just as the pallet forks are viewed as an implement for the implement carrier.

Of the accessories list on FIG. 22 perhaps only the wheel clamp adapter needs clarification. Clamped onto any piece of square tubing from trailer frame to cattle chute, it offers a sleeve tube receiver for the caster wheel, winch post, etc. Thus anything with a relevant size square tube section can be equipped with wheels, winch or other components from the kit.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A kit of parts for assembling into a multiple-configuration implement carrier for supporting a plurality of different implements thereon, the kit of parts comprising:
a frame comprising a base and an upright extending upwardly from the base arranged to support at least some of the plurality of implements thereon spaced above the base; and
a plurality of wheels arranged to support the frame for rolling movement along the ground;
the wheels being arranged to be supported in a first configuration in which a first one of the implements is arranged to be supported on the frame and in a second configuration, different from the first configuration, in which a second one of the implements is arranged to be supported on the frame.

2. The kit according to claim 1 wherein the first and second configurations of the wheels are different in lateral spacing relative to one another in a direction transverse to a longitudinal direction of rolling movement of the wheels.

3. The kit according to claim 1 wherein the first and second configurations of the wheels are different in orientation of a longitudinal direction of rolling movement relative to one another.

4. The kit according to claim 1 wherein the first and second configurations of the wheels are different in longitudinal spacing relative to one another in a longitudinal direction of rolling movement of the wheels.

5. The kit according to claim 1 wherein the wheels include at least one caster wheel having a variable direction of rolling movement and at least one fixed wheel having a fixed direction of rolling movement, both said at least one caster wheel and said at least one fixed wheel being arranged to be supported on the frame in more than one configuration.

6. The kit according to claim 1 wherein at least some of the wheels are supported on the frame by telescoping members arranged to be supported for sliding movement relative to the frame.

7. The kit according to claim 1 wherein the frame is arranged to be supported on a vehicle, the wheels being arranged to be removed from the frame when the frame is supported on the vehicle.

8. The kit according to claim 1 in combination with first and second implements arranged for different functions, the first implement being supported on the frame in the first configuration of the wheels and the second implement being supported on the frame in the second configuration of the wheels.

9. The kit according to claim 1 wherein the frame is comprised of a plurality of first frame members comprising elongate members having an outer dimension of prescribed dimension and a plurality of second frame members comprising elongate members having an inner dimension substantially equal to the prescribed dimension, each of the plurality of first frame members being arranged for telescoping connection with each of the plurality of second frame members.

10. The kit according to claim 1 wherein there is provided a lift carriage supported for lifting movement along the upright, the lift carriage being arranged to support at least one of the implements thereon.

11. The kit according to claim 10 wherein the lift carriage comprises a pair of vertically spaced apart rails spanning generally horizontally and being arranged to support the implement thereon, a vertical space between the rails being arranged to be adjustable.

12. The kit according to claim 10 wherein the lift carriage includes a plurality of clevis mounts supported thereon, at least some of the clevis mounts being vertically and horizontally spaced from one another and at least some of the clevis mounts being adjustable in height relative to one another.

13. The kit according to claim 10 wherein the lift carriage includes a plurality of clevis mounts supported thereon, at least some of the clevis mounts being vertically and horizontally spaced from one another and at least some of the clevis mounts being supported on the lift carriage for relative sliding movement in a generally horizontal direction relative to one another.

14. The kit according to claim 10 wherein there is provided a winch operable between the frame and the lift carriage in a first mode to apply a lifting force to the lift carriage and in a second mode to apply a downward force to the lift carriage.

15. The kit according to claim 10 wherein there is provided a pair of horizontal lift forks supported on carriage parallel and spaced apart from one another, the lift forks being arranged to support one of the implements thereon.

16. The kit according to claim 15 wherein each lift fork comprises a mounting member arranged to be supported in an upright orientation on the carriage and a lift member extending generally horizontally from one end of the mounting member, the mounting member being mountable on the lift carriage in a first configuration in which the lift member extends from a top end of the mounting member and a second configuration in which the left member extends from a bottom end of the mounting member.

17. The kit according to claim 15 wherein the lift forks have mounting apertures at spaced positions therealong so as to be arranged to support one of the implements thereon using fasteners cooperating with the mounting apertures.

18. The kit according to claim 10 wherein there is provided an electric motor for driving one of either lifting of the lift carriage relative to the frame or rolling of the frame relative to the ground, the electric motor being powered by batteries arranged to be supported on the lift carriage when a ground engaging implement is supported on the lift carriage.

19. The kit according to claim 1 wherein there is provided at least one modular motor unit arranged to drive rotation of one of the wheels, the modular motor unit being mountable in a first position engaged for driving one of the wheels and in a second position engaged for driving a different one of the wheels.

20. The kit according to claim 19 wherein there is provided a lift carriage supported for lifting movement along the upright and wherein the modular motor unit is mountable in a third position for driving the lifting movement of the lift carriage along the upright.
